(19) United States
(12) Patent Application Publication
(10) Pub. No.: US 2024/0118398 A1
(43) Pub. Date: Apr. 11, 2024

(54) DETECTION METHOD OF LASER DETECTION APPARATUS AND LASER DETECTION APPARATUS

(71) Applicant: SUTENG INNOVATION TECHNOLOGY CO., LTD., Shenzhen (CN)

(72) Inventor: Peng JIANG, Shenzhen (CN)

(73) Assignee: SUTENG INNOVATION TECHNOLOGY CO., LTD., Shenzhen (CN)

(21) Appl. No.: 18/234,366

(22) Filed: Aug. 15, 2023

(30) Foreign Application Priority Data
Sep. 30, 2022 (CN) 202211214522.2

(51) Int. Cl. G01S 7/4913; G01S 7/4911; G01S 7/4912; G01S 17/58

(52) U.S. Cl. CPC G01S 7/4913; G01S 7/4911; G01S 7/4917; G01S 17/58

(57) ABSTRACT

This application provides a detection method of a laser detection apparatus and the laser detection apparatus, where the detection method includes: controlling two lasers with different emission power respectively to emit triangular wave signals with different sweep slopes and in opposite sweep directions to the target object in the same sweep period; then receiving local oscillator signals; and further based on a magnitude relationship of the power of the two lasers, a value of the sweep slope, and frequency of the local oscillator signals and the beat frequency signal of the corresponding echo signal, determining a moving direction and a speed of the target object.

### CROSS-REFERENCE TO RELATED APPLICATION

The present application claims the benefit of priority to Chinese Patent Application No. 202211214522.2, filed on Sep. 30, 2022, which is hereby incorporated by reference in its entirety.

### TECHNICAL FIELD

This application relates to the technical field of frequency-modulated continuous-wave (FMCW) LiDAR (Light Detection and Range), and in particular, relates to a detection method of a laser detection apparatus, the laser detection apparatus, and a storage medium.

### BACKGROUND

Frequency-modulated continuous-wave LiDARs can measure both distance and speed, are widely used in fields of smart transportation and autonomous driving, and can provide safer and more reliable distance and speed information for autonomous driving or assisted driving. Compared with a solution using only a time-of-flight (TOF) ranging technology, the frequency-modulated continuous-wave LiDAR can measure a speed of the target object and a distance between the LiDAR and the target object.

Currently, dual lasers can be disposed in the same channel of frequency-modulated continuous-wave LiDAR, so that the dual lasers can perform detection as per the same optical path, which can theoretically implement detection with higher resolution. However, there is yet no specific method for calculating a speed and a distance in the dual-laser detection method.

### SUMMARY

Embodiments of this application provide a detection method of a laser detection apparatus, the laser detection apparatus, and a storage medium, to improve a current status of lacking the specific method for calculating speed and distance in existing dual-laser detection methods.

A first aspect of the embodiments of this application provides a detection method of a laser detection apparatus, including: controlling a first laser to generate a first triangular wave signal in each sweep period, where emission power of the first laser is first power, a sweep slope of the first triangular wave signal is a first slope, and the sweep period includes first sweep time and second sweep time connected in sequence; controlling a second laser to generate a second triangular wave signal in each sweep period, where emission power of the second laser is second power different from the first power, a sweep slope of the second triangular wave signal is second slope, and the second slope is different from the first slope; controlling a photoelectric detection module to receive a first local oscillator signal, an echo signal of a first detection signal, a second local oscillator signal and an echo signal of a second detection signal, where the first local oscillator signal and the first detection signal are two signals formed via beam splitting of the first triangular wave signal, the first local oscillator signal includes a first upper-sweep local oscillator signal at the first sweep time and a second lower-sweep local oscillator signal at the second sweep time, the first detection signal includes a first upper-sweep detection signal at the first sweep time and a second lower-sweep detection signal at the second sweep time, the second local oscillator signal and the second detection signal are two signals formed via beam splitting of the second triangular wave signal, the second local oscillator signal includes a first lower-sweep local oscillator signal at the first sweep time and a second upper-sweep local oscillator signal at the second sweep time, and the second detection signal includes a first lower-sweep detection signal at the first sweep time and a second upper-sweep detection signal at the second sweep time; obtaining first frequency and second frequency at the first sweep time, where the first frequency is a higher one of frequency of a first beat frequency signal and frequency of a second beat frequency signal, the second frequency is a lower one of the frequency of the first beat frequency signal and the frequency of the second beat frequency signal, the first beat frequency signal is a beat frequency signal of the first upper-sweep local oscillator signal and an echo signal of the first upper-sweep detection signal, and the second beat frequency signal is a beat frequency signal of the first lower-sweep local oscillator signal and an echo signal of the first lower-sweep detection signal; obtaining third frequency and fourth frequency at the second sweep time, where the third frequency is a higher one of frequency of a third beat frequency signal and frequency of a fourth beat frequency signal, the fourth frequency is a lower one of the frequency of the third beat frequency signal and the frequency of the fourth beat frequency signal, the third beat frequency signal is a beat frequency signal of the second lower-sweep local oscillator signal and an echo signal of the second lower-sweep detection signal, and the fourth beat frequency signal is a beat frequency signal of the second upper-sweep local oscillator signal and an echo signal of the second upper-sweep detection signal; based on a magnitude relationship between the first power and the second power and a magnitude relationship between amplitudes of the first frequency and the second frequency, determining a moving direction of a target object relative to the laser detection apparatus at the first sweep time; or based on a magnitude relationship between the first power and the second power and a magnitude relationship between amplitudes of the third frequency and the fourth frequency, determining a moving direction of a target object relative to the laser detection apparatus at the second sweep time; and based on the moving direction, the first frequency, the second frequency, the third frequency, the fourth frequency, the first slope, the second slope, and central frequency of the first triangular wave signal and/or the second triangular wave signal, determining a speed of the target object relative to the laser detection apparatus and a distance there between.

A second aspect of the embodiments of this application provides a laser detection apparatus, including: a first laser emission unit, configured to control a first laser to generate a first triangular wave signal in each sweep period, where emission power of the first laser is first power, a sweep slope of the first triangular wave signal is a first slope, and the sweep period includes first sweep time and second sweep time connected in sequence; a second laser emission unit, configured to control a second laser to generate a second triangular wave signal in each sweep period, where emission power of the second laser is second power different from the first power, a sweep slope of the second triangular wave signal is second slope, and the second slope is different from the first slope; a photoelectric conversion unit, configured to control a photoelectric detection module to receive a first local oscillator signal, an echo signal of a first detection signal, a second local oscillator signal and an echo signal of a second detection signal, where the first local oscillator signal and the first detection signal are two signals formed via beam splitting of the first triangular wave signal, the first local oscillator signal includes a first upper-sweep local oscillator signal at the first sweep time and a second lower-sweep local oscillator signal at the second sweep time, the first detection signal includes a first upper-sweep detection signal at the first sweep time and a second lower-sweep detection signal at the second sweep time, the second local oscillator signal and the second detection signal are two signals formed via beam splitting of the second triangular wave signal, the second local oscillator signal includes a first lower-sweep local oscillator signal at the first sweep time and a second upper-sweep local oscillator signal at the second sweep time, and the second detection signal includes a first lower-sweep detection signal at the first sweep time and a second upper-sweep detection signal at the second sweep time; a first frequency obtaining unit, configured to obtain first frequency and second frequency at the first sweep time, where the first frequency is a higher one of frequency of a first beat frequency signal and frequency of a second beat frequency signal, the second frequency is a lower one of the frequency of the first beat frequency signal and the frequency of the second beat frequency signal, the first beat frequency signal is a beat frequency signal of the first upper-sweep local oscillator signal and an echo signal of the first upper-sweep detection signal, and the second beat frequency signal is a beat frequency signal of the first lower-sweep local oscillator signal and an echo signal of the first lower-sweep detection signal; a second frequency obtaining unit, configured to obtain third frequency and fourth frequency at the second sweep time, where the third frequency is a higher one of frequency of a third beat frequency signal and frequency of a fourth beat frequency signal, the fourth frequency is a lower one of the frequency of the third beat frequency signal and the frequency of the fourth beat frequency signal, the third beat frequency signal is a beat frequency signal of the second lower-sweep local oscillator signal and an echo signal of the second lower-sweep detection signal, and the fourth beat frequency signal is a beat frequency signal of the second upper-sweep local oscillator signal and an echo signal of the second upper-sweep detection signal; a moving direction determining unit, configured to: based on a magnitude relationship between the first power and the second power and a magnitude relationship between amplitudes of the first frequency and the second frequency, determine a moving direction of a target object relative to the laser detection apparatus at the first sweep time; or based on a magnitude relationship between the first power and the second power and a magnitude relationship between amplitudes of the third frequency and the fourth frequency, determine a moving direction of a target object relative to the laser detection apparatus at the second sweep time; and a distance and speed determining unit, configured to: based on the moving direction, the first frequency, the second frequency, the third frequency, the fourth frequency, the first slope, the second slope, and central frequency of the first triangular wave signal and/or the second triangular wave signal, determine a speed of the target object relative to the laser detection apparatus and a distance there between.

A third aspect of the embodiments of this application provides a laser detection apparatus, including: a processor; and a memory connected with the processor communicatively, where the memory stores a program executable by the processor, and the processor is configured to run the program, so that the laser detection apparatus performs steps of the detection method according to the first aspect of the embodiments of this application.

A fourth aspect of the embodiments of this application provides a computer-readable storage medium, where the computer-readable storage medium stores a computer program, and when the computer program is executed by a processor, steps of the detection method according to the first aspect of the embodiments of this application are implemented.

In the detection method provided in the first aspect of the embodiments of this application, two lasers with different emission power are respectively controlled to emit triangular wave signals with different sweep slopes and in opposite sweep directions to the target object in the same sweep period. Then the photoelectric detection module receives the local oscillator signals from the two lasers and the echo signal formed after the detection signal is reflected by the target object. Next, based on the magnitude relationship of the power of the two lasers, the value of the sweep slope, and frequency of the local oscillator signals and the beat frequency signal of the corresponding echo signal, the moving direction and the speed of the target object relative to the laser detection apparatus and the distance there between are determined. In the detection method, the current status of lacking the specific method for calculating the speed and the distance in the dual-laser detection method can be improved. It should be noted that in the detection method, the same photoelectric detection module receives the local oscillator signals from the two lasers and the echo signals, and therefore, hardware costs and an overall volume of the laser detection apparatus can be reduced.

For beneficial effects of the foregoing second to fourth aspects, refer to relevant description in the first aspect. Details are not described herein again.

### BRIEF DESCRIPTION OF DRAWINGS

To explain the technical solution in embodiments in this application, the following briefly introduces the accompanying drawings. The accompanying drawings in the following description are only some embodiments in this application.

FIG. 1 is the first schematic diagram of the flow of the detection method provided in an embodiment of the present application;

FIG. 2 is a diagram of a beat frequency principle and a spectrum in an embodiment that distance beat frequency is greater than or equal to speed beat frequency when a target object approaches a laser detection apparatus if first power is greater than second power and a first slope is greater than a second slope;

FIG. 3 is a diagram of a beat frequency principle and a spectrum in an embodiment that distance beat frequency is less than speed beat frequency when a target object approaches a laser detection apparatus if first power is greater than second power and a first slope is greater than a second slope;

FIG. 4 is a diagram of a beat frequency principle and a spectrum in an embodiment that distance beat frequency is greater than or equal to speed beat frequency when a target object does not approach a laser detection apparatus if first power is greater than second power and a first slope is greater than a second slope;

FIG. 5 is a diagram of a beat frequency principle and a spectrum in an embodiment that distance beat frequency is less than speed beat frequency when a target object does not approach a laser detection apparatus if first power is greater than second power and a first slope is greater than a second slope;

FIG. 6 is the second schematic diagram of the flow of the detection method provided in an embodiment of the present application; and

FIG. 7 is the third schematic diagram of the flow of the detection method provided in an embodiment of the present application; and

FIG. 8 is the first schematic diagram of the structure of a device for detecting a laser provided in an embodiment of the present application;

FIG. 9 is the second schematic diagram of the structure of a device for detecting a laser provided in an embodiment of the present application; and

FIG. 10 is the third schematic diagram of the structure of a device for detecting a laser provided in an embodiment of the present application.

### DETAILED DESCRIPTION

For the purpose of illustration rather than limitation, the following describes details such as a system structure and technology, to facilitate a thorough understanding of the embodiments of the present application.

A term “include” indicates existence of a described feature, integrity, a step, an operation, an element, and/or a component, but does not exclude existence or addition of one or more other features, integrity, steps, operations, elements, components, and/or a collection thereof.

The term “and/or” used in this specification and appended claims of the present application refers to any combination of one or more of the associated items listed and all possible combinations thereof, and inclusion of these combinations.

As used in this specification and the appended claims of the present application, depending on the context, the term “if” can be interpreted as “when,” “once,” “in response to determination,” or “in response to detection”. Similarly, depending on the context, the phrase “if determined” or “if (a described condition or event is) detected” can be interpreted as “once determined,” “in response to determination,” “once (the described condition or event is) detected,” or “in response to detection (of the described condition or event)”.

In addition, in the descriptions of this specification and the appended claims of the present application, the terms “first,” “second,” “third” and the like are merely intended for differential description, and should not be understood as any indication or implication of relative importance.

Reference to “an embodiment,” “some embodiments,” or the like described in this specification of the present application means that one or more embodiments of the present application include a specific feature, structure, or characteristic described with reference to the embodiments. Therefore, expressions such as “in an embodiment,” “in some embodiments,” “in some other embodiments,” and “in some additional embodiments” appearing in different places in this specification do not necessarily indicate reference to the same embodiment, but mean “one or more but not all embodiments,” unless otherwise specified in another way. The terms “include,” “comprise,” “have,” and variants thereof all mean “including but not limited to,” unless otherwise specified in another way. The term “multiple” and a variation thereof mean “at least two”.

An embodiment of this application provides a detection method of a laser detection apparatus, where the detection method can be executed by a processor of the laser detection apparatus when running a computer program with a corresponding function. Two lasers with different emission power are respectively controlled to emit triangular wave signals with different sweep slopes and in opposite sweep directions to the target object in the same sweep period. In some embodiments, the triangular wave signal means a triangular wave sweep signal. Then the same photoelectric detection module receives the local oscillator signals from the two lasers and the echo signal formed after the detection signal is reflected by the target object. Next, based on the magnitude relationship of the power of the two lasers, the value of the sweep slope, and frequency of the local oscillator signals and the beat frequency signal of the corresponding echo signal, the moving direction and the speed of the target object relative to the laser detection apparatus and the distance there between are determined. In the detection method, the current status of lacking the specific method for calculating the speed and the distance in the dual-laser detection method can be improved. In the detection method, the same photoelectric detection module receives the local oscillator signals from the two lasers and the echo signals, and therefore, hardware costs and an overall volume of the laser detection apparatus can be reduced.

When being applied, the detection method provided in this embodiment of this application is applicable to fast, efficient and accurate distance measurement and speed measurement of both a short-distance target and a long-distance target, and is applicable to any field that needs distance measurement and speed measurement, for example, smart transportation, aerospace, resource exploration, urban planning, agricultural development, hydro project, land use, environmental monitoring, metallurgical manufacturing, or textile manufacturing. In some embodiments, the detection method is applicable to an unmanned vehicle, an unmanned aerial vehicle, a robot, a positioning system, a navigation system, loading, unloading and handling of equipment, metallurgical process controlling equipment, contact-free measuring equipment, and the like. When the detection method provided in this embodiment of this application is used for the distance measurement and the speed measurement of the short-distance target, the distance and the speed can be decoupled, thereby effectively improving resolution and a duty cycle for the distance measurement and the speed measurement. A short distance may be any distance selected from 0 m to 100 m, for example, 10 m, 20 m, or 50 m.

In an embodiment, the laser detection apparatus can be a LiDAR, or a signal processing device in the LiDAR, or any device with distance and speed measurement functions, for example, a distance and speed measurement sensor or a distance and speed meter. The laser detection apparatus may include a first laser, a second laser, an optical beam splitter, an optical multiplexer, a scanning system, a photoelectric detection module, and a signal processing device, and may also include an optical amplifier, an optical coupler, an optical circulator, an optical collimator, an optical beam combiner, an interferometer, a power module, a communications module, and the like.

In an embodiment, the first laser and the second laser can be implemented via any laser capable of emitting a linear sweep optical signal in a chirp mode, for example, a semiconductor laser such as a distributed Bragg reflector (DBR) laser or a distributed feedback (DFB) laser. The LiDAR may also include more than two lasers. Some lasers are configured to implement a function of the first laser, and other lasers are configured to implement a function of the second laser.

In an embodiment, the optical beam splitter may be any device capable of splitting light, to split a signal generated by the first laser or the second laser into a corresponding local oscillator signal and a detection signal in a preset beam splitting ratio. For example, the optical beam splitter may be an element such as an optical coupler or a beam splitting prism.

In an embodiment, the photoelectric detection module can be any device that can receive the local oscillator signals corresponding to the two lasers, and echo signals formed after detection signals corresponding to the two lasers are reflected by the target object, and output an electrical signal related to a beat frequency signal corresponding to the local oscillator signal of the first laser, and an electrical signal related to a beat frequency signal corresponding to the local oscillator signal of the second laser, so that the signal processing device obtains frequency of the foregoing two beat frequency signals based on the foregoing electrical signal. For example, the photoelectric detection module may include a photodetector. At this time, when the photodetector receives the foregoing local oscillator signal and echo signal, the local oscillator signal and the echo signal are subjected to frequency beating via frequency beating of a free-space optical signal, and the photodetector performs photoelectric conversion on the beat frequency signal to obtain an electrical signal related to the beat frequency signal. For example, the photoelectric detection module may also include an optical frequency mixer and a balanced photodetector (BPD). At this time, the optical frequency mixer is configured to receive the local oscillator signal and the echo signal, to subject the local oscillator signal and the echo signal to frequency beating in the optical frequency mixer, and the balanced photodetector is configured to perform balanced detection on the beat frequency signal, to obtain the electrical signal related to the beat frequency signal.

In an embodiment, the optical amplifier may be a fiber amplifier such as Erbium-Doped Fiber Amplifier (EDFA). In addition, the optical amplifier may also be a semiconductor optical amplifier.

In an embodiment, the optical coupler can be implemented via an array of optical fibers or an array of planar lightwave circuits (PLC).

In an embodiment, an interferometer may be a Mach-Zehnder interferometer.

In an embodiment, the signal processing device may include a processor, and may also include at least one level of amplification circuits, an analog-to-digital converter (ADC), a time-to-digital converter (TDC), a memory, and the like. The processor can also be equipped with internal storage space and an analog-to-digital conversion function to replace the analog-to-digital converter and the memory.

In an embodiment, the processor may be a central processing unit (CPU), or may be another general-purpose processor, a digital signal processor (DSP), an application specific integrated circuit (ASIC), a field-programmable gate array (FPGA) or another programmable logic device, a discrete gate or transistor logic device, a discrete hardware component, or the like. The general-purpose processor can be a microprocessor, or any conventional processor or the like.

In an embodiment, the memory may be an internal storage unit of the laser detection apparatus, for example, a hard disk or a memory of the laser detection apparatus. The memory may be an external storage device of the laser detection apparatus in some other embodiments, for example, a plug-connected hard disk, a smart media card (SMC), a secure digital (SD) card, or a flash card (Flash Card) equipped on the laser detection apparatus. Further, the memory may include both the internal storage unit and the external storage device of the laser detection apparatus. The memory is configured to store an operating system, an application program, a boot loader (Boot Loader), data, another program, and the like, for example, program code of a computer program. The memory can also be configured to temporarily store output data or to-be-output data.

In an embodiment, the amplification circuit can be implemented via a trans-impedance amplifier (TIA).

In an embodiment, the power module may include a power management device, a power interface, and the like.

In an embodiment, the communications module can be set as any device capable of implementing direct or indirect wired or wireless communication with another device based on an actual need. For example, the communications module can provide communication solutions including, for example, a communication interface (for example, a universal serial bus (USB) interface), wired Local Area Network (LAN), Wireless Local Area Network (WLAN) (for example, a Wi-Fi network), Bluetooth, Zigbee, a mobile communication network, Global Navigation Satellite System (GNSS), Frequency Modulation (FM), Near Field Communication (NFC), and Infrared (IR) applied to a network device. The communications module may include an antenna, and the antenna may have only one array element, or may be an antenna array including multiple array elements. The communications module can receive electromagnetic waves via the antenna, frequency-modulate and filter the electromagnetic wave signal, and send a processed signal to the processor. The communications module can also receive a to-be-sent signal from the processor, frequency-modulate and amplify the signal, and convert the signal into the electromagnetic wave for radiation via the antenna.

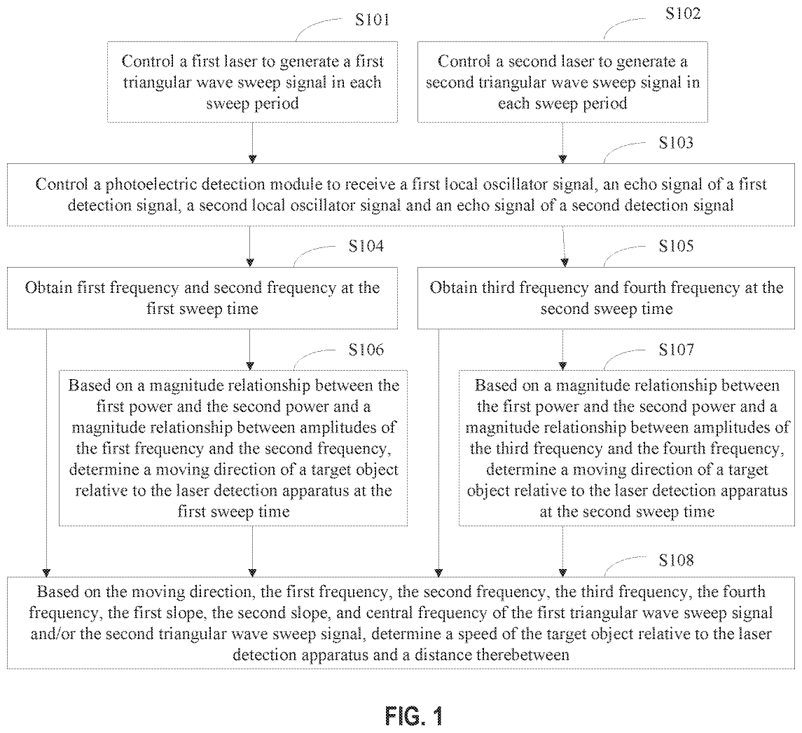

As shown in FIG. 1, the detection method in this embodiment of this application may include the following steps S101 to S108.

Step S101: Control a first laser to generate a first triangular wave signal in each sweep period, and go to step S103.

In an embodiment, the signal processing device controls the first laser to emit a first triangular wave signal with first power in each sweep period, and the first triangular wave signal is a linear sweep signal. The sweep period includes first sweep time and second sweep time joined in sequence, and the first sweep time and the second sweep time are equal and can be set to any time length based on an actual need. Emission optical power (OP) of the first laser is a constant first power P₁, and the first power P₁ can be set based on an actual need.

In an embodiment, the first triangular wave signal is split into a first local oscillator signal and a first detection signal by the optical beam splitter, the first local oscillator signal is transmitted to the photoelectric detection module for local reference, and the first detection signal is transmitted to a target object to detect the target object. The first local oscillator signal includes a first upper-sweep local oscillator signal at the first sweep time and a second lower-sweep local oscillator signal at the second sweep time, the first detection signal includes a first upper-sweep detection signal at the first sweep time and the second lower-sweep detection signal at the second sweep time, and the first upper-sweep local oscillator signal, the second lower-sweep local oscillator signal, the first upper-sweep detection signal and the second lower-sweep detection signal are all linear sweep signals. Sweep slopes of the first upper-sweep local oscillator signal and the first upper-sweep detection signal are positive and equal, sweep slopes of the second lower-sweep local oscillator signal and the second lower-sweep detection signal are negative and equal, and sweep slopes of the first upper-sweep local oscillator signal and the second lower-sweep local oscillator signal are equal. For ease of description, in this application, the sweep slope of the first triangular wave signal is defined as the first slope Kᵤ, and sweep slopes of the first upper-sweep local oscillator signal, the second lower-sweep local oscillator signal, the first upper-sweep detection signal and the second lower-sweep detection signal are all the first slope Kᵤ.

In an embodiment, frequency of the first upper-sweep local oscillator signal and the first upper-sweep detection signal changes linearly from first initial frequency to first stop frequency within the first sweep time, and a change rate of the frequency (that is, a sweep slope) is positive and remains unchanged within the first sweep time. Frequency of the second lower-sweep local oscillator signal and the second lower-sweep detection signal changes linearly from the first stop frequency to the first initial frequency within the second sweep time, and a changing rate of the frequency is negative and remains unchanged within the second sweep time. An average of the first initial frequency and the first stop frequency is center frequency f₀₁ of the first laser, and the center frequency f₀₁ of the first laser can be set based on an actual need. The first stop frequency is equal to a positive product of first sweep time and the sweep slope of the first upper-sweep detection signal plus the first initial frequency.

Step S102: Control a second laser to generate a second triangular wave signal in each sweep period, and go to step S103.

In an embodiment, the signal processing device controls the second laser to emit a second triangular wave signal in each sweep period, and the second triangular wave signal is a linear sweep signal and has a sweep direction opposite to that of the first triangular wave signal. The emission optical power of the second laser is a constant second power P₂, the second power P₂ can be set to any value different from the first power P₁ based on an actual need, and a magnitude relationship between the first power and the second power can be set based on an actual need. In some embodiments, the first power P₁ is greater than the second power P₂. For example, both the first power and the second power satisfy: P₁>1.05P₂. For example, in some other embodiments, the first power P1 is less than the second power P₂. For example, both the first power and the second power satisfy: P₁<0.95P₂.

In an embodiment, the second triangular wave signal is split into a second local oscillator signal and a second detection signal by the optical beam splitter, the second local oscillator signal is transmitted to the photoelectric detection module for local reference, and the second detection signal is transmitted to a target object to detect the target object. The second local oscillator signal includes a first lower-sweep local oscillator signal at the first sweep time and a second upper-sweep local oscillator signal at the second sweep time, the second detection signal includes a first lower-sweep detection signal at the first sweep time and the second upper-sweep detection signal at the second sweep time, and the first lower-sweep local oscillator signal, the second upper-sweep local oscillator signal, the first lower-sweep detection signal and the second upper-sweep detection signal are all linear sweep signals. Sweep slopes of the first lower-sweep local oscillator signal and the first lower-sweep detection signal are negative and equal, and sweep slopes of the second upper-sweep local oscillator signal and the second upper-sweep detection signal are positive and equal. For ease of description, in this application, the sweep slope of the second triangular wave signal is defined as the second slope K_{d}, and sweep slopes of the first lower-sweep local oscillator signal, the second upper-sweep local oscillator signal, the first lower-sweep detection signal and the second upper-sweep detection signal are all the second slope K_{d}. A ratio of the second slope to the first slope is defined as a first coefficient α, satisfying

$$α = \frac{{K}_{u}}{{K}_{d}} .$$

The sweep slope of the first triangular wave sweep signal has a different value from the sweep slope of the second triangular wave signal, and a magnitude relationship therebetween can be set based on an actual need. For example, in some embodiments, the second slope K_{d} is less than the first slope Kᵤ, that is, 0<α<1.

In an embodiment, frequency of the first lower-sweep local oscillator signal and the first lower-sweep detection signal changes linearly from second initial frequency to second stop frequency within the first sweep time, and a change rate of the frequency (that is, a sweep slope) is negative and remains unchanged within the first sweep time. Frequency of the second upper-sweep local oscillator signal and the second upper-sweep detection signal changes linearly from the second stop frequency to the second initial frequency within the second sweep time, and a changing rate of the frequency is positive and remains unchanged within the second sweep time. An average of the second initial frequency and the second stop frequency is center frequency f₀₂ of the second laser, and the center frequency f₀₂ of the second laser can be set based on an actual need. The second stop frequency is equal to a negative product of second sweep time and the sweep slope of the first lower-sweep detection signal plus the second initial frequency. It should be noted that center frequency of the first triangular wave signal and center frequency of the second triangular wave signal are close, that is, a ratio of a difference between the center frequency of the first triangular wave signal and the center frequency of the second triangular wave signal to either of the center frequency of the first triangular wave signal and the center frequency of the second triangular wave signal is small. For example, the ratio is less than one thousandth. For example, two signals are 905 nm signals, and the wavelength difference between the two signals is 0.05 nm to 0.5 nm.

In an embodiment, at the first sweep time, the first upper-sweep detection signal and the first lower-sweep detection signal are incident at the same position of the target object, defined as the first position, to detect a distance between the first position of the target object and the laser detection apparatus at the first sweep time. Similarly, at the second sweep time, the second lower-sweep detection signal and the second upper-sweep detection signal are incident at the same position of the target object, defined as the second position, to detect a distance between the second position of the target object and the laser detection apparatus at the second sweep time. A method of controlling the first detection signal and the second detection signal to be incident at the same position of the same target object may be to emit the first detection signal and the second detection signal through the same optical path for detection. Based on this, echo signals of the first detection signal and the second detection signal can also enter the photoelectric detection module through the same optical path.

In an embodiment, because a position of the target object relative to the laser detection apparatus changes during movement, it cannot be ensured that each laser signal emitted by the laser detection apparatus can be incident at the same position of the target object. Therefore, the first position and the second position may be the same position or different positions.

Step S103: Control a photoelectric detection module to receive a first local oscillator signal, an echo signal of a first detection signal, a second local oscillator signal and an echo signal of a second detection signal, and go to step S104 and step S105.

In an embodiment, the first optical beam splitter is connected with the first laser, and is configured to split the first triangular wave signal into the first local oscillator signal and the first detection signal. The first local oscillator signal enters the photoelectric detection module through an optical path such as optical waveguide and/or a free-space optical path. The first detection signal is incident on the surface of the target object, and is reflected by the target object to form a corresponding echo signal, and the echo signal enters the photoelectric detection module through the optical path such as the free-space optical path and/or the optical waveguide. The second optical beam splitter is connected with the second laser, and is configured to split the second triangular wave signal into the second local oscillator signal and the second detection signal. The second local oscillator signal enters the photoelectric detection module through an optical path such as optical waveguide and/or a free-space optical path. The second detection signal is incident on the surface of the target object, and is reflected by the target object to form a corresponding echo signal, and the echo signal enters the photoelectric detection module through the optical path such as the free-space optical path and/or the optical waveguide.

When the photoelectric detection module receives the first local oscillator signal, the echo signal of the first detection signal, the second local oscillator signal and the echo signal of the second detection signal, the first local oscillator signal and the echo signal of the first detection signal are subjected to frequency beating, the first beat frequency signal is generated at the first sweep time, the third beat frequency signal is generated at the second sweep time, and the photoelectric detection module can convert the foregoing first beat frequency signal and third beat frequency signal into corresponding electrical signals, so that the signal processing device obtains frequency of the first beat frequency signal and the third beat frequency signal based on the electrical signals. When the photoelectric detection module receives the first local oscillator signal, the echo signal of the first detection signal, the second local oscillator signal and the echo signal of the second detection signal, the second local oscillator signal and the echo signal of the second detection signal are subjected to frequency beating, the second beat frequency signal is generated at the first sweep time, the fourth beat frequency signal is generated at the second sweep time, and the photoelectric detection module can convert the foregoing second beat frequency signal and fourth beat frequency signal into corresponding electrical signals, so that the signal processing device obtains frequency of the second beat frequency signal and the fourth beat frequency signal based on the electrical signals.

Step S104: Obtain first frequency and second frequency at the first sweep time, and go to step S106 and step S108.

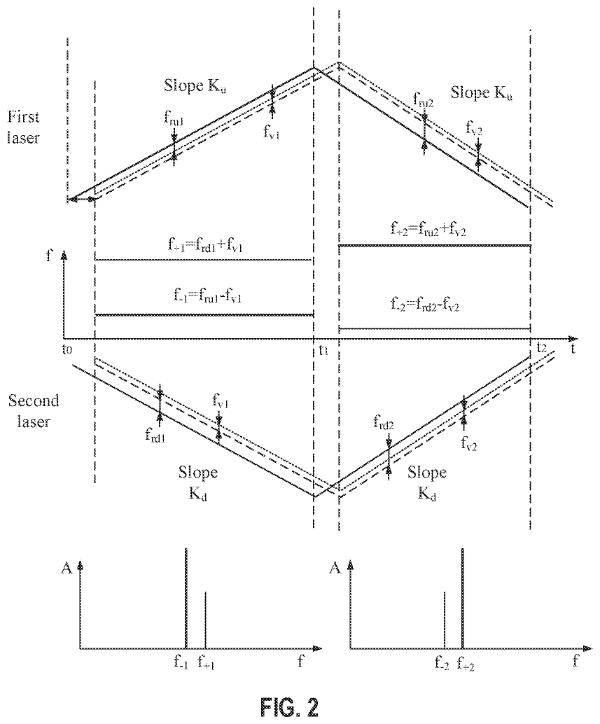

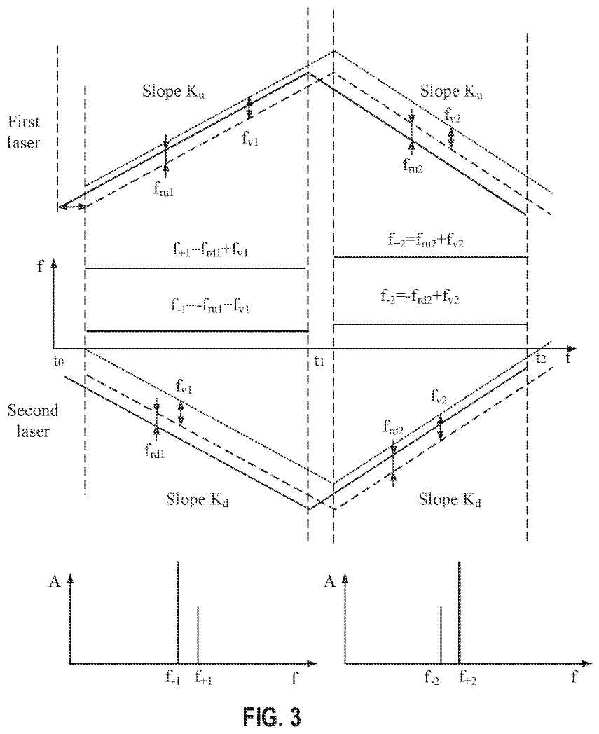

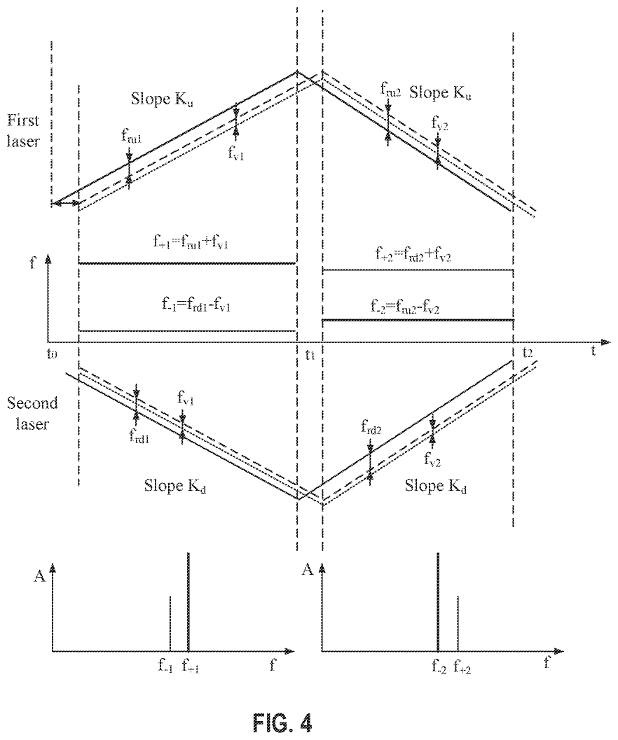

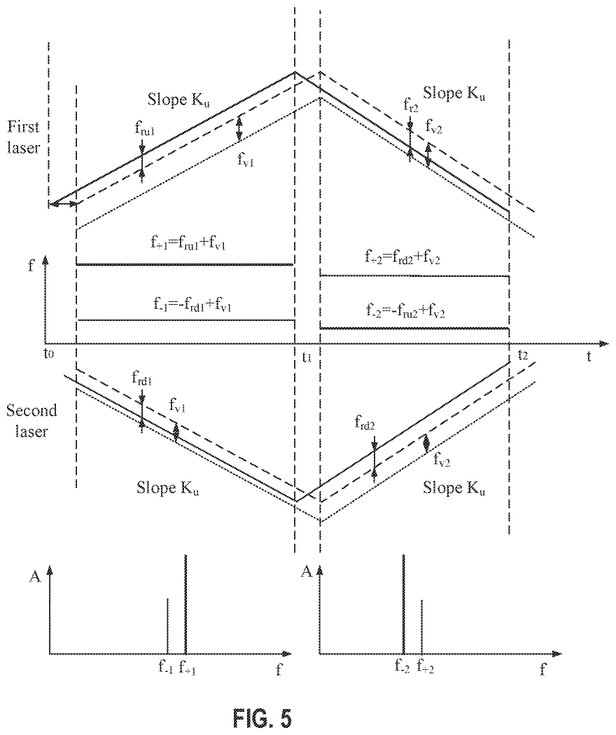

A condition that the first power P₁ is greater than the second power P₂ and the first slope Kᵤ is greater than the second slope K_{d} is used as an example to describe the method. Referring to FIG. 2 to FIG. 5, FIG. 2 is a diagram of a beat frequency principle and a spectrum in a case that distance beat frequency is greater than or equal to speed beat frequency when a target object approaches a laser detection apparatus in the foregoing condition; FIG. 3 is a diagram of a beat frequency principle and a spectrum in a case that distance beat frequency is less than speed beat frequency when a target object approaches a laser detection apparatus in the foregoing condition; FIG. 4 is a diagram of a beat frequency principle and a spectrum in a case that distance beat frequency is greater than or equal to speed beat frequency when a target object does not approach a laser detection apparatus in the foregoing condition; and FIG. 5 is a diagram of a beat frequency principle and a spectrum in a case that distance beat frequency is less than speed beat frequency when a target object does not approach a laser detection apparatus in the foregoing condition. In the foregoing figures, an upper black solid line represents the first local oscillator signal, an upper black wide-spaced dotted line represents the reference signal, and represents an echo signal of the first detection signal when the target object is stationary relative to the laser detection apparatus, and there is only relative displacement between the echo signal and the first local oscillator signal on a time axis (t). An upper black narrow-space dotted line represents the echo signal of the first detection signal, there is relative displacement between the echo signal and the reference signal on a frequency axis (f), time from t0 (initial position on the time axis) to t1 (position of a second dotted line on the time axis) represents the first sweep time, and duration of the first sweep time is equal to t1 minus t0. Likewise, a lower black solid line represents the second local oscillator signal, a lower black wide-spaced dotted line represents the reference signal, and represents an echo signal of the second detection signal when the target object is stationary relative to the laser detection apparatus, and there is only relative displacement between the echo signal and the second local oscillator signal on a time axis (t). A lower black narrow-space dotted line represents the echo signal of the second detection signal, there is relative displacement between the echo signal and the reference signal on a frequency axis (f), time from t1 to t2 (position of a fourth dotted line on the time axis) represents the second sweep time, and duration of the second sweep time is equal to t2 minus t1. A beat frequency signal of the first upper-sweep local oscillator signal and the echo signal of the first upper-sweep detection signal is a first beat frequency signal, a beat frequency signal of the first lower-sweep local oscillator signal and the echo signal of the first lower-sweep detection signal is a second beat frequency signal, a beat frequency signal of the second lower-sweep local oscillator signal and the second lower-sweep detection signal is a third beat frequency signal, and a beat frequency signal of the second upper-sweep local oscillator signal and the second upper-sweep detection signal is a fourth beat frequency signal.

In an embodiment, the first frequency f₊₁ is a higher one of the frequency of the first beat frequency signal and the frequency of the second beat frequency signal, and the second frequency f₋₁ is a lower one of the frequency of the first beat frequency signal and the frequency of the second beat frequency signal. At the first sweep time, the photoelectric detection module receives the first upper-sweep local oscillator signal and the echo signal corresponding to the first upper-sweep detection signal, and the first upper-sweep local oscillator signal and the echo signal are subjected to frequency beating to generate the first beat frequency signal. The photoelectric detection module receives the first lower-sweep local oscillator signal and the echo signal of the first lower-sweep detection signal, and the first lower-sweep local oscillator signal and the echo signal are subjected to frequency beating to generate the second beat frequency signal. The photoelectric detection module converts the first beat frequency signal and the second beat frequency signal into a first electrical signal and a second electrical signal, and sends the first electrical signal and the second electrical signal to the signal processing device. The signal processing device analyzes and processes the first electrical signal and the second electrical signal through, for example, Fourier transform processing and peak searching, to obtain the first frequency f₊₁ with a higher value and the second frequency f₋₁ with a lower value. That is, the first frequency f₊₁ is a higher one of the frequency of the first beat frequency signal and the frequency of the second beat frequency signal, and the second frequency f₋₁ is a lower one of the frequency of the first beat frequency signal and the frequency of the second beat frequency signal.

Step S105: Obtain third frequency and fourth frequency at the second sweep time, and go to step S107 and step S108.

In an embodiment, the third frequency f₊₂ is a higher one of the frequency of the third beat frequency signal and the frequency of the fourth beat frequency signal, and the fourth frequency f₋₂ is a lower one of the frequency of the third beat frequency signal and the frequency of the fourth beat frequency signal. At the second sweep time, the photoelectric detection module receives the second lower-sweep local oscillator signal and the echo signal corresponding to the second lower-sweep detection signal, and the second lower-sweep local oscillator signal and the echo signal are subjected to frequency beating to generate the third beat frequency signal. The photoelectric detection module receives the second upper-sweep local oscillator signal and the echo signal of the second upper-sweep detection signal, and the second upper-sweep local oscillator signal and the echo signal are subjected to frequency beating to generate the fourth beat frequency signal. The photoelectric detection module converts the third beat frequency signal and the fourth beat frequency signal into a third electrical signal and a fourth electrical signal, and sends the third electrical signal and the fourth electrical signal to the signal processing device. The signal processing device analyzes and processes the third electrical signal and the fourth electrical signal through, for example, Fourier transform processing and peak searching, to obtain the third frequency f₊₂ with a higher value and the fourth frequency f₋₂ with a lower value. That is, the third frequency f₊₂ is a higher one of the frequency of the third beat frequency signal and the frequency of the fourth beat frequency signal, and the fourth frequency f₋2 is a lower one of the frequency of the third beat frequency signal and the frequency of the fourth beat frequency signal.

Step S106: Based on a magnitude relationship between the first power and the second power and a magnitude relationship between amplitudes of the first frequency and the second frequency, determine a moving direction of a target object relative to the laser detection apparatus at the first sweep time, and go to step S108.

Step S107: Based on a magnitude relationship between the first power and the second power and a magnitude relationship between amplitudes of the third frequency and the fourth frequency, determine a moving direction of a target object relative to the laser detection apparatus at the second sweep time, and go to step S108.

In an embodiment, after the signal processing device obtains the frequency of the two beat frequency signals at each sweep time, based on a magnitude relationship between the known first power and second power, and a magnitude relationship between amplitudes of the frequency of the two beat frequency signals obtained at each sweep time, the moving direction of the target object relative to the laser detection apparatus at each sweep time can be determined. “Magnitude of certain frequency” in this application refers to an energy value of a signal corresponding to the frequency on a spectrogram. On the spectrogram, the frequency and the energy of the signal are respectively represented by an abscissa and an ordinate. For example, the amplitude of the first frequency is represented by an ordinate of a beat frequency signal on the spectrogram that corresponds to the first frequency (that is, a higher one of the first beat frequency signal and the second beat frequency signal). As shown in FIG. 2, the amplitude of the first frequency is less than that of the second frequency.

Step S108: Based on the moving direction, the first frequency, the second frequency, the third frequency, the fourth frequency, the first slope, the second slope, and central frequency of the first triangular wave signal and/or the second triangular wave signal, determine a speed of the target object relative to the laser detection apparatus and a distance therebetween.

In an embodiment, after determining the moving direction of the target object relative to the laser detection apparatus in each sweep period, the signal processing device further determines a speed of the target object relative to the laser detection apparatus and a distance therebetween in each sweep period based on the moving direction of the target object relative to the laser detection apparatus in each sweep period, the frequency of the beat frequency signal, the first slope, the second slope, and the center frequency of the first triangular wave signal and/or the second triangular wave signal. The moving direction of the target object relative to the laser detection apparatus in each sweep period can be the moving direction of the target object relative to the laser detection apparatus at the first sweep time or the second sweep time, and one of step S106 and step S107 can be selected and executed based on an actual need to obtain a corresponding moving direction as the moving direction of the target object relative to the laser detection apparatus in each sweep period. “Determining the speed of the target object relative to the laser detection apparatus and the distance therebetween based on the moving direction, the first frequency, the second frequency, the third frequency, the fourth frequency, the first slope, the second slope, and the center frequency of the first triangular wave signal and/or the second triangular wave signal” in this application indicates that when the speed of the target object relative to the laser detection apparatus and the distance therebetween are calculated, parameters such as the moving direction of the target object relative to the laser detection apparatus, the first frequency, the second frequency, the third frequency, the fourth frequency, the first slope, and the second slope need to be used, and at least one of the center frequency of the first triangular wave signal and the center frequency of the second triangular wave signal also needs to be used.

In an embodiment, step S106 includes:

if the first power is greater than the second power and the amplitude of the first frequency is less than the amplitude of the second frequency, determining that the target object approaches the laser detection apparatus at the first sweep time; or if the amplitude of the first frequency is greater than the amplitude of the second frequency, determining that the target object does not approach the laser detection apparatus at the first sweep time.

Referring to FIG. 2 to FIG. 5, in some embodiments, if the first power is set to be greater than the second power in advance, or the signal processing device obtains the first power greater than the second power in another method, at the first sweep time, when the signal processing device determines that an amplitude A(f₊₁) of the first frequency is less than an amplitude A(f₋) of the second frequency, it can be determined that the target object approaches the laser detection apparatus; otherwise, when the amplitude A(f₊₁) of the first frequency is greater than the amplitude A(f₋₁) of the second frequency, it is determined that the target object does not approach the laser detection apparatus. Situations that the target object does not approach the laser detection apparatus include two cases, the target object leaves the laser detection apparatus, and the target object is stationary relative to the laser detection apparatus.

In another embodiment, step S106 includes:

if the first power is less than the second power and the amplitude of the first frequency is greater than the amplitude of the second frequency, determining that the target object approaches the laser detection apparatus at the first sweep time; or if the amplitude of the first frequency is less than the amplitude of the second frequency, determining that the target object does not approach the laser detection apparatus at the first sweep time.

In an embodiment, if the first power is set to be less than the second power in advance, or the signal processing device obtains the first power less than the second power in another method, at the first sweep time, when the signal processing device determines that an amplitude A(f₊₁) of the first frequency is greater than an amplitude A(f₋₁) of the second frequency, it can be determined that the target object approaches the laser detection apparatus; otherwise, when the amplitude A(f₊₁) of the first frequency is less than the amplitude A(f₋₁) of the second frequency, it is determined that the target object does not approach the laser detection apparatus.

In an embodiment, step S107 includes:

if the first power is greater than the second power and the amplitude of the third frequency is greater than the amplitude of the fourth frequency, determining that the target object approaches the laser detection apparatus at the second sweep time; or if the amplitude of the third frequency is less than the amplitude of the fourth frequency, determining that the target object does not approach the laser detection apparatus at the second sweep time.

Referring to FIG. 2 to FIG. 5, in some embodiments, if the first power is set to be greater than the second power in advance, or the signal processing device obtains the first power greater than the second power in another method, at the second sweep time, when the signal processing device determines that an amplitude A(f₊₂) of the third frequency is greater than an amplitude A(f₋₂) of the fourth frequency, it can be determined that the target object approaches the laser detection apparatus; otherwise, when the amplitude A(f₊₂) of the third frequency is less than the amplitude A(f₋₂) of the fourth frequency, it is determined that the target object does not approach the laser detection apparatus.

In another embodiment, step S107 includes:

if the first power is less than the second power and the amplitude of the third frequency is less than the amplitude of the fourth frequency, determining that the target object approaches the laser detection apparatus at the second sweep time; or if the amplitude of the third frequency is greater than the amplitude of the fourth frequency, determining that the target object does not approach the laser detection apparatus at the second sweep time.

In some embodiments, if the first power is set to be less than the second power in advance, or the signal processing device obtains the first power greater than the second power in another method, at the second sweep time, when the signal processing device determines that an amplitude A(f₊₂) of the third frequency is less than an amplitude A(f₋₂) of the fourth frequency, it can be determined that the target object approaches the laser detection apparatus; otherwise, when the amplitude A(f₊₂) of the third frequency is greater than the amplitude A(f₋₂) of the fourth frequency, it is determined that the target object does not approach the laser detection apparatus.

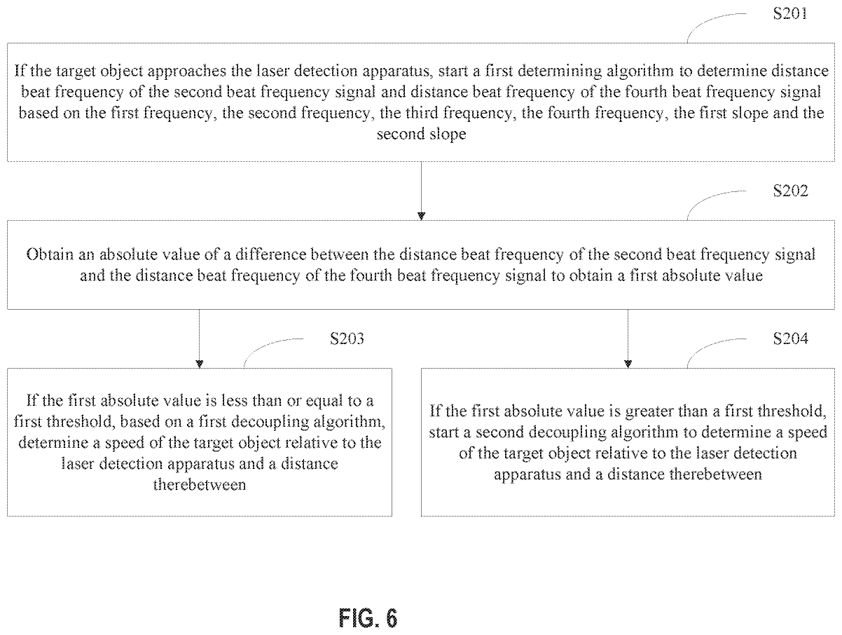

As shown in FIG. 6, in an embodiment, for a situation where the target object approaches the laser detection apparatus, step S108 includes the following step S201 to step S204.

Step S201: If the target object approaches the laser detection apparatus, start a first determining algorithm to determine distance beat frequency of the second beat frequency signal and distance beat frequency of the fourth beat frequency signal based on the first frequency, the second frequency, the third frequency, the fourth frequency, the first slope and the second slope, and go to step S202.

Step S202: Obtain an absolute value of a difference between the distance beat frequency of the second beat frequency signal and the distance beat frequency of the fourth beat frequency signal to obtain a first absolute value, and go to step S203 or step S204.

Step S203: If the first absolute value is less than or equal to a first threshold, based on a first decoupling algorithm, determine a speed of the target object relative to the laser detection apparatus and a distance therebetween.

Step S204: If the first absolute value is greater than a first threshold, start a second decoupling algorithm to determine the speed of the target object relative to the laser detection apparatus and a distance therebetween.

The foregoing first determining algorithm is configured to: for a scenario in which the target object approaches the laser detection apparatus and the first beat frequency signal to the fourth beat frequency signal all satisfy that the distance beat frequency is greater than or equal to speed beat frequency, determine the distance beat frequency of the second beat frequency signal and the distance beat frequency of the fourth beat frequency signal. That is, the first determining algorithm corresponds to a scenario shown in FIG. 2. The first decoupling algorithm is configured to: for a scenario in which the target object approaches the laser detection apparatus and the first beat frequency signal to the fourth beat frequency signal all satisfy that the distance beat frequency is greater than or equal to speed beat frequency, calculate the speed of the target object relative to the laser detection apparatus and the distance therebetween. That is, the first decoupling algorithm corresponds to a scenario shown in FIG. 2. The second decoupling algorithm is configured to: for a scenario in which the target object approaches the laser detection apparatus and the first beat frequency signal to the fourth beat frequency signal all satisfy that the distance beat frequency is less than speed beat frequency, calculate the speed of the target object relative to the laser detection apparatus and the distance therebetween. That is, the second decoupling algorithm corresponds to a scenario shown in FIG. 3.

In an embodiment, the beat frequency of the local oscillator signal generated by the laser detection apparatus during detection and the echo signal of the detection signal is actually obtained by coupling the distance beat frequency and the speed beat frequency. The distance beat frequency is difference frequency caused during frequency beating of the detection signal and the local oscillator signal because of displacement of the detection signal relative to the local oscillator signal during the time of flight, has a value equal to a product of the sweep slope of the detection signal and the time of flight of the detection signal, and depends on only the time of flight other than the speed of the target object. The speed beat frequency is difference frequency caused during frequency beating of the detection signal and the local oscillator signal because of a Doppler frequency shift effect caused by the speed of the target object, and has a value equal to a quotient of dividing twice a radial velocity of the target object relative to the laser detection apparatus by a wavelength of the detection signal. It can be seen that the distance beat frequency is fᵣ=k×τ, the speed beat frequency is

$${f}_{v} = \frac{2 \times v}{λ} = \frac{2 \times v \times {f}_{0}}{c} ,$$

and the beat frequency of the local oscillator signal and the echo signal is fₚ=|fᵣ±fᵥ|, where τ is the time of flight of the detection signal, v is the radial velocity of the target object relative to the laser detection apparatus, λ is the wavelength (center wavelength) of the detection signal, c is the speed of light, and f₀ is the center frequency of the detection signal.

FIG. 2 to FIG. 5 show the first frequency, the second frequency, the third frequency, and the fourth frequency in various scenarios according to some embodiments of the present application. The first beat frequency signal has distance beat frequency denoted as fᵣᵤ₁, and speed beat frequency denoted as fᵥ₁; the second beat frequency signal has distance beat frequency denoted as f_{rd1}, and speed beat frequency denoted as fᵥ₁; the third beat frequency signal has the distance beat frequency denoted as fᵣᵤ₂, and speed beat frequency denoted as fᵥ₂; and the fourth beat frequency signal has the distance beat frequency denoted as f_{rd2}, and speed beat frequency denoted as fᵥ₂. Because the speed beat frequency depends on only the relative radial velocity of the target object and the center frequency (or center wavelength) of the detection signal, and the frequency difference between the first triangular wave signal and the second triangular wave signal is extremely small relative to their respective frequency (wavelengths). For example, a wavelength difference between the two signals is 0.1 nm to 0.3 nm, and therefore, the speed beat frequency of the first beat frequency signal can be considered to be consistent with that of the second beat frequency signal.

In each sweep period, when the signal processing device determines that the moving direction of the target object is towards the laser detection apparatus (corresponding to FIG. 2 and FIG. 3), the first determining algorithm is first started to separately calculate the distance beat frequency f_{rd1} of the second beat frequency signal and the distance beat frequency f_{rd2} of the fourth beat frequency signal; and then an absolute value of a difference between the distance beat frequency f_{rd1} of the second beat frequency signal and the distance beat frequency f_{rd2} of the fourth beat frequency signal is calculated, to obtain the first absolute value Δf₁. Because the first determining algorithm is actually used to calculate the distance beat frequency f_{rd1} of the second beat frequency signal and the distance beat frequency f_{rd2} of the fourth beat frequency signal with respect to the scenario in FIG. 2, and then is used to: based on magnitude of the first absolute value Δf₁ and the first threshold f₁, determine whether a magnitude relationship between the distance beat frequency f_{rd1} of the second beat frequency signal and the distance beat frequency f_{rd2} of the fourth beat frequency signal satisfies applicable scenarios of the first determining algorithm and the first decoupling algorithm (that is, the scenarios corresponding to FIG. 2), if the first absolute value Δf₁ is less than or equal to the first threshold f₁, the applicable scenario of the first decoupling algorithm (that is, the scenario corresponding to FIG. 2) is satisfied, and the first decoupling algorithm is started to calculate the speed of the target object relative to the laser detection apparatus and the distance therebetween; otherwise, it is determined that the magnitude relationship between the distance beat frequency f_{rd1} of the second beat frequency signal and the distance beat frequency f_{rd2} of the fourth beat frequency signal satisfies the applicable scenario of the second decoupling algorithm (that is, the scenario corresponding to FIG. 3), and at this time, the speed of the target object relative to the laser detection apparatus and the distance therebetween are calculated based on the second decoupling algorithm.

In an embodiment, when an applicable scenario of the first determining algorithm is satisfied, the distance beat frequency f_{rd1} of the second beat frequency signal is calculated based on the first frequency f₊₁ and the second frequency f₋₁ obtained at the first sweep time, and the known first slope Kᵤ and second slope K_{d}. A formula for calculating the distance beat frequency f_{rd1} of the second beat frequency signal is as follows:

$${f}_{r d 1} = \frac{{f}_{+ 1} + {f}_{- 1}}{1 + \frac{{K}_{u}}{{K}_{d}}}$$

In an embodiment, when an applicable scenario of the first determining algorithm is satisfied, the distance beat frequency f_{rd2} of the fourth beat frequency signal may be calculated based on the third frequency f₋₂ and the fourth frequency f₊₂ obtained at the second sweep time, and the known first slope Kᵤ and second slope K_{d}. In this case, a formula for calculating the distance beat frequency f_{rd2} of the fourth beat frequency signal is as follows:

$${f}_{r d 2} = \frac{{f}_{+ 2} + {f}_{- 2}}{1 + \frac{{K}_{u}}{{K}_{d}}}$$

In another embodiment, when the applicable scenario of the first decoupling algorithm is satisfied, if a difference between the second frequency f₋₁ obtained at the first sweep time and the third frequency f₋₂ obtained at the second sweep time is equal to a difference f₋₁−f₋₂=fᵣᵤ₁−f_{rd2} between the distance beat frequency fᵣᵤ₁ of the first beat frequency signal and the distance beat frequency f_{rd2} of the fourth beat frequency signal, the distance beat frequency f_{rd2} of the fourth beat frequency signal may also be calculated based on the second frequency f₋₁ obtained at the first sweep time and the third frequency f₋₂ obtained at the second sweep time, and the known first slope Kᵤ and second slope K_{d}. In this case, a formula for calculating the distance beat frequency f_{rd2} of the fourth beat frequency signal is as follows:

$${f}_{r d 2} = \frac{{f}_{- 1} - {f}_{- 2}}{\frac{{K}_{u}}{{K}_{d}} - 1}$$

The two methods for calculating the distance beat frequency f_{rd2} of the fourth beat frequency signal can be selected.

In an embodiment, when the target object is stationary relative to the laser detection apparatus, the distance beat frequency f_{rd1} of the second beat frequency signal is equal to the distance beat frequency f_{rd2} of the fourth beat frequency signal; and when the target object approaches or leaves the laser detection apparatus, the distance beat frequency f_{rd1} of the second beat frequency signal is close to but unequal to the distance beat frequency f_{rd2} of the fourth beat frequency signal, and a difference therebetween is small. The first threshold f₁ can be set to a small value, for example, 0.05 times f_{rd1}, 0.1 times f_{rd1} or 0.15 times f_{rd1} based on the absolute value of the difference between the distance beat frequency f_{rd1} of the second beat frequency signal and the distance beat frequency f_{rd2} of the fourth beat frequency signal. The first threshold can also be set to a small fixed value.

Even though the first determining algorithm is used for identifying the scenario by comparing the absolute value of the difference between the distance beat frequency of the second beat frequency signal and the distance beat frequency of the fourth beat frequency signal with the first threshold in the foregoing embodiments, in another embodiment of this application, the first determining algorithm may also be used for identifying the scenario by comparing the absolute value of the difference between the distance beat frequency of the first beat frequency signal and the distance beat frequency of the third beat frequency signal with the first threshold.

In another embodiment, for a situation where the target object approaches the laser detection apparatus, step S107 includes:

if the target object approaches the laser detection apparatus and the second frequency is greater than the fourth frequency, starting a first decoupling algorithm to determine a speed of the target object relative to the laser detection apparatus and a distance therebetween; or

if the target object approaches the laser detection apparatus and the second frequency is less than the fourth frequency, starting a second decoupling algorithm to determine a speed of the target object relative to the laser detection apparatus and a distance therebetween.

In an embodiment, for a situation where the target object approaches the laser detection apparatus, an embodiment of this application also provides a simplified method for determining the speed of the target object relative to the laser detection apparatus and the distance therebetween. In each sweep period, when the signal processing device determines that the moving direction of the target object is towards the laser detection apparatus, a current scenario is first determined based on the magnitude relationship between the second frequency f₋₁ and the fourth frequency f₋₂. If the second frequency f₋₁ is greater than the fourth frequency f₋₂, the applicable scenario of the foregoing first decoupling algorithm is satisfied, and the first decoupling algorithm is started to calculate the speed of the target object relative to the laser detection apparatus and the distance therebetween; otherwise, it is determined that the applicable scenario of the second decoupling algorithm is satisfied, and at this time, the first decoupling algorithm is switched to the second decoupling algorithm, and the speed of the target object relative to the laser detection apparatus and the distance therebetween are calculated based on the second decoupling algorithm.

In an embodiment, a step of starting a first decoupling algorithm to determine a speed of the target object relative to the laser detection apparatus and a distance therebetween includes:

based on the first frequency, the second frequency, the first slope and the second slope, determining a first distance between the target object and the laser detection apparatus at the first sweep time. The distance beat frequency f_{rd1} of the second beat frequency signal may be determined first based on the first frequency f₊₁, the second frequency f₋₁, the first slope Kᵤ and the second slope K_{d} through, for example, the following formula (1). Then based on the distance beat frequency f_{rd1} of the second beat frequency signal and the second slope K_{d}, the first distance r₁ is determined through, for example, the following formula (5). During actual calculation, the first distance r₁ can be calculated directly through the formula (5).

Based on the first frequency, the second frequency, the first slope, the second slope, and central frequency of the first triangular wave signal and/or the second triangular wave signal, a first speed of the target object relative to the laser detection apparatus at the first sweep time is determined. In some embodiments, the distance beat frequency fᵣᵤ₁ of the first beat frequency signal may be determined first based on the first slope Kᵤ, the second slope K_{d}, and the distance beat frequency f_{rd1} of the second beat frequency signal through, for example, the following formula (2). Then the speed beat frequency fᵥ₁ of the first beat frequency signal and the second beat frequency signal are determined based on the first frequency f₊₁, the second frequency f₋₁, the distance beat frequency fᵣᵤ₁ of the first beat frequency signal, and the distance beat frequency f_{rd1} of the second beat frequency signal through, for example, the following formula (7).

Then, based on the speed beat frequency fᵥ₁ of the foregoing first beat frequency signal or second beat frequency signal, and the center frequency f₀₁ of the first triangle wave signal (or the center frequency f₀₂ of the second triangle wave signal, or an average f₀₃ of the center frequency of the first triangle wave signal and the center frequency of the second triangle wave signal), the speed of the target object relative to the laser detection apparatus at the first sweep time is determined through, for example, the following formula (9), where f₀ can be the center frequency of the first triangle wave signal or the center frequency of the second triangle wave signal, or the average of the center frequency of the first triangle wave signal and the center frequency of the second triangle wave signal, that is, one of f₀₁, f₀₂ and f₀₃.

Based on the third frequency, the fourth frequency, the first slope, and the second slope, the distance beat frequency of the fourth beat frequency signal and the second distance of the target object relative to the laser detection apparatus at the second sweep time are determined. In some embodiments, the distance beat frequency f_{rd2} of the fourth beat frequency signal may be determined first based on the third frequency f₊₂, the fourth frequency f₋₂, the first slope Kᵤ, and the second slope K_{d} through, for example, the following formula (3). Then based on the distance beat frequency f_{rd2} of the fourth beat frequency signal and the second slope K_{d}, the second distance r₂ is determined through, for example, the following formula (6). During actual calculation, the first distance r₂ can be calculated directly through the formula (6).

Based on the third frequency, the fourth frequency, the first slope, the second slope, and central frequency of the first triangular wave signal and/or the second triangular wave signal, a second speed of the target object relative to the laser detection apparatus at the second sweep time is determined. In some embodiments, the distance beat frequency fᵣᵤ₂ of the third beat frequency signal may be determined first based on the first slope Kᵤ, the second slope K_{d}, and the distance beat frequency f_{rd2} of the fourth beat frequency signal through, for example, the following formula (4). Then the speed beat frequency fᵥ₂ of the third beat frequency signal and the fourth beat frequency signal are determined based on the third frequency f₊₂, the fourth frequency f₋₂, the distance beat frequency fᵣᵤ₂ of the third beat frequency signal, and the distance beat frequency f_{rd2} of the fourth beat frequency signal through, for example, the following formula (8).

Then, based on the speed beat frequency fᵥ₂ of the foregoing third beat frequency signal or fourth beat frequency signal, and the center frequency f₀₁ of the first triangle wave signal (or the center frequency f₀₁ of the second triangle wave signal, or an average f₀₃ of the center frequency of the first triangle wave signal and the center frequency of the second triangle wave signal), the second speed v₂ of the target object relative to the laser detection apparatus at the first sweep time is determined through, for example, the following formula (10), where f₀ can be the center frequency of the first triangle wave signal or the center frequency of the second triangle wave signal, or the average of the center frequency of the first triangle wave signal and the center frequency of the second triangle wave signal, that is, one of f₀₁, f₀₂ and f₀₃.

In an embodiment, the first decoupling algorithm includes but is not limited to the following formulas:

$${f}_{r d 1} = \frac{{f}_{+ 1} + {f}_{- 1}}{1 + \frac{{K}_{u}}{{K}_{d}}} = {K}_{d} Δ {t}_{1} \qquad ( 1 )$$

$${f}_{ru 1} = \frac{{K}_{u}}{{K}_{d}} * {f}_{r d 1} \qquad ( 2 )$$

$${f}_{r d 2} = \frac{{f}_{+ 2} + {f}_{- 2}}{1 + \frac{{K}_{u}}{{K}_{d}}} = {K}_{d} Δ {t}_{2} \qquad ( 3 )$$

$${f}_{ru 2} = \frac{{K}_{u}}{{K}_{d}} * {f}_{r d 2} \qquad ( 4 )$$

$${r}_{1} = \frac{c}{2} \frac{{f}_{+ 1} + {f}_{- 1}}{( 1 + \frac{{K}_{u}}{{K}_{d}} ) {K}_{d}} \qquad ( 5 )$$

$${r}_{2} = \frac{c}{2} \frac{{f}_{+ 2} + {f}_{- 2}}{( 1 + \frac{{K}_{u}}{{K}_{d}} ) {K}_{d}} \qquad ( 6 )$$

$${f}_{v 1} = \frac{{f}_{+ 1} - {f}_{- 1} + {f}_{r u 1} - {f}_{r d 1}}{2} \qquad ( 7 )$$

$${f}_{v 2} = \frac{{f}_{+ 2} - {f}_{- 2} - {f}_{ru 2} + {f}_{r d 2}}{2} \qquad ( 8 )$$

$${v}_{1} = \frac{c {f}_{ν 1}}{2 {f}_{0}} \qquad ( 9 )$$

$${v}_{2} = \frac{c {f}_{ν 2}}{2 {f}_{0}} \qquad ( 10 )$$

where f₊₁ represents the first frequency, f₋₁ represents the second frequency, f_{rd1} represents the distance beat frequency of the second beat frequency signal, fᵣᵤ₁ represents the distance beat frequency of the first beat frequency signal, Kᵤ represents the first slope, K_{d} represents the second slope, Δt₁ represents time of flight of a first lower-sweep detection signal, f₊₂ represents the third frequency, f₋₂ represents the fourth frequency, f_{rd2} represents the distance beat frequency of the fourth beat frequency signal, Δt₂ represents time of flight of a second upper-sweep detection signal, fᵣᵤ₂ represents the distance beat frequency of the third beat frequency signal, r₁ represents the first distance, c represents a propagation speed of light in the air, r₂ represents the second distance, fᵥ₁ represents the speed beat frequency of the first beat frequency signal and the second beat frequency signal, fᵥ₂ represents the speed beat frequency of the third beat frequency signal and the fourth beat frequency signal, v₁ represents the first speed, v₂ represents the second speed, and f₀ represents the central frequency of the first triangular wave signal or the second triangular wave signal, or represents an average of the central frequency of the first triangular wave signal and the central frequency of the second triangle wave signal.

In an embodiment, a step of starting a second decoupling algorithm to determine a speed of the target object relative to the laser detection apparatus and a distance therebetween includes:

based on the first frequency, the second frequency, the first slope, and the second slope, determining a first distance between the target object and the laser detection apparatus at the first sweep time. In some embodiments, the distance beat frequency f_{rd1} of the second beat frequency signal may be determined first based on the first frequency f₊₁, the second frequency f₋₁, the first slope Kᵤ and the second slope K_{d} through, for example, the following formula (11). Then based on the distance beat frequency f_{rd1} of the second beat frequency signal and the second slope K_{d}, the first distance r₁ is determined through, for example, the following formula (15). During actual calculation, the first distance r₁ can be calculated directly through the formula (15).

Based on the first frequency, the second frequency, the first slope, the second slope, and central frequency of the first triangular wave signal and/or the second triangular wave signal, a first speed of the target object relative to the laser detection apparatus at the first sweep time is determined. In some embodiments, the distance beat frequency fᵣᵤ₁ of the first beat frequency signal may be determined first based on the first slope Kᵤ, the second slope K_{d}, and the distance beat frequency f_{rd1} of the second beat frequency signal through, for example, the following formula (12). Then the speed beat frequency fᵥ₁ of the first beat frequency signal and the second beat frequency signal are determined based on the first frequency f₊₁, the second frequency f₋₁, the distance beat frequency fᵣᵤ₁ of the first beat frequency signal, and the distance beat frequency f_{rd1} of the second beat frequency signal through, for example, the following formula (17).

Then, based on the speed beat frequency fᵥ₁ of the foregoing first beat frequency signal or second beat frequency signal, and the center frequency f₀₁ of the first triangle wave signal (or the center frequency f₀₂ of the second triangle wave signal, or an average f₀₃ of the center frequency of the first triangle wave signal and the center frequency of the second triangle wave signal), the speed of the target object relative to the laser detection apparatus at the first sweep time is determined through, for example, the following formula (19), where f₀ can be the center frequency of the first triangle wave signal or the center frequency of the second triangle wave signal, or the average of the center frequency of the first triangle wave signal and the center frequency of the second triangle wave signal, that is, one of f₀₁, f₀₂ and f₀₃.

Based on the third frequency, the fourth frequency, the first slope and the second slope, the distance beat frequency of the fourth beat frequency signal and the second distance of the target object relative to the laser detection apparatus at the second sweep time are determined. In some embodiments, the distance beat frequency f_{rd2} of the fourth beat frequency signal may be determined first based on the third frequency f₊₂, the fourth frequency f₋₂, the first slope Kᵤ and the second slope K_{d} through, for example, the following formula (13). Then based on the distance beat frequency f_{rd2} of the fourth beat frequency signal and the second slope K_{d}, the second distance r₂ is determined through, for example, the following formula (16). During actual calculation, the first distance r₂ can be calculated directly through the formula (16).

Based on the third frequency, the fourth frequency, the first slope, the second slope, and central frequency of the first triangular wave signal and/or the second triangular wave signal, a second speed of the target object relative to the laser detection apparatus at the second sweep time is determined. The distance beat frequency fᵣᵤ₂ of the third beat frequency signal may be determined first based on the first slope Kᵤ, the second slope K_{d}, and the distance beat frequency f_{rd2} of the fourth beat frequency signal through, for example, the following formula (14). Then the speed beat frequency frog of the third beat frequency signal and the fourth beat frequency signal are determined based on the third frequency f₊₂, the fourth frequency f₋₂, the distance beat frequency fᵣᵤ₂ of the third beat frequency signal, and the distance beat frequency f_{rd2} of the fourth beat frequency signal through, for example, the following formula (18).

Then, based on the speed beat frequency fᵥ₂ of the foregoing third beat frequency signal or fourth beat frequency signal, and the center frequency f₀₁ of the first triangle wave signal (or the center frequency f₀₁ of the second triangle wave signal, or an average f₀₃ of the center frequency of the first triangle wave signal and the center frequency of the second triangle wave signal), the second speed v₂ of the target object relative to the laser detection apparatus at the first sweep time is determined through, for example, the following formula (20), where f₀ can be the center frequency of the first triangle wave signal or the center frequency of the second triangle wave signal, or the average of the center frequency of the first triangle wave signal and the center frequency of the second triangle wave signal, that is, one of f₀₁, f₀₂ and f₀₃.

In an embodiment, the second decoupling algorithm includes but is not limited to the following formulas:

$${f}_{r d 1} = \frac{{f}_{+ 1} - {f}_{- 1}}{1 + \frac{{K}_{u}}{{K}_{d}}} = {K}_{d} Δ {t}_{1} \qquad ( 11 )$$

$${f}_{r u 1} = \frac{{K}_{u}}{{K}_{d}} * {f}_{r d 1} \qquad ( 12 )$$

$${f}_{r d 2} = \frac{{f}_{+ 2} - {f}_{- 2}}{1 + \frac{{K}_{u}}{{K}_{d}}} = {K}_{d} Δ {t}_{2} \qquad ( 13 )$$

$${f}_{r u 2} = \frac{{K}_{u}}{{K}_{d}} * {f}_{r d 2} \qquad ( 14 )$$

$${r}_{1} = \frac{c}{2} \frac{{f}_{+ 1} - {f}_{- 1}}{( 1 + \frac{{K}_{u}}{{K}_{d}} ) {K}_{d}} \qquad ( 15 )$$

$${r}_{2} = \frac{c}{2} \frac{{f}_{+ 2} - {f}_{- 2}}{( 1 + \frac{{K}_{u}}{{K}_{d}} ) {K}_{d}} \qquad ( 16 )$$

$${f}_{v 1} = \frac{{f}_{+ 1} + {f}_{- 1} + {f}_{r u 1} - {f}_{r d 1}}{2} \qquad ( 17 )$$

$${f}_{v 2} = \frac{{f}_{+ 2} + {f}_{- 2} - {f}_{r u 2} + {f}_{r d 2}}{2} \qquad ( 18 )$$

$${v}_{1} = \frac{c {f}_{v 1}}{2 {f}_{0}} \qquad ( 19 )$$

$${v}_{2} = \frac{c {f}_{v 2}}{2 {f}_{0}} \qquad ( 20 )$$

where f₊₁ represents the first frequency, f₋₁ represents the second frequency, f_{rd1} represents the distance beat frequency of the second beat frequency signal, fᵣᵤ₁ represents the distance beat frequency of the first beat frequency signal, Kᵤ represents the first slope, K_{d} represents the second slope, Δt₁ represents time of flight of a first lower-sweep detection signal, f₊₂ represents the third frequency, f₋₂ represents the fourth frequency, f_{rd2} represents the distance beat frequency of the fourth beat frequency signal, Δt₂ represents time of flight of a second upper-sweep detection signal, fᵣᵤ₂ represents the distance beat frequency of the third beat frequency signal, r₁ represents the first distance, c represents a propagation speed of light in the air, r₂ represents the second distance, fᵥ₁ represents the speed beat frequency of the first beat frequency signal and the second beat frequency signal, fᵥ₂ represents the speed beat frequency of the third beat frequency signal and the fourth beat frequency signal, v₁ represents the first speed, v₂ represents the second speed, and f₀ represents the central frequency of the first triangular wave signal or the second triangular wave signal, or represents an average of the central frequency of the first triangular wave signal and the central frequency of the second triangle wave signal.

In an embodiment, if the first slope is greater than the second slope, the detection method further includes an initial check step for checking initially whether the speed of the target object relative to the laser detection apparatus and the distance therebetween calculated based on the first decoupling algorithm or the second decoupling algorithm are correct, including:

if the first decoupling algorithm is started, determining a distance beat frequency and a speed beat frequency of a second beat frequency signal, and a distance beat frequency and a speed beat frequency of a fourth beat frequency signal based on the first decoupling algorithm, where the step can be performed during or after step S108; and

if the distance beat frequency of the second beat frequency signal is greater than or equal to the speed beat frequency, and the distance beat frequency of the fourth beat frequency signal is greater than or equal to the speed beat frequency, determining that the speed of the target object relative to the laser detection apparatus and the distance therebetween that are determined based on the first coupling algorithm pass a check; otherwise, determining that the speed of the target object relative to the laser detection apparatus and the distance therebetween that are determined based on the first coupling algorithm fail the check, where the first decoupling algorithm can be switched to the second decoupling algorithm at this time; or

if the second decoupling algorithm is started, determining a distance beat frequency and a speed beat frequency of a second beat frequency signal, and a distance beat frequency and a speed beat frequency of a fourth beat frequency signal based on the second decoupling algorithm, where the step can be performed during or after step S108; and

if the distance beat frequency of the second beat frequency signal is less than the speed beat frequency, and the distance beat frequency of the fourth beat frequency signal is less than the speed beat frequency, determining that the speed of the target object relative to the laser detection apparatus and the distance therebetween that are determined based on the second coupling algorithm pass a check; otherwise, determining that the speed of the target object relative to the laser detection apparatus and the distance therebetween that are determined based on the second coupling algorithm fail the check, discarding the speed of the target object relative to the laser detection apparatus and the distance therebetween that are determined in this sweep period at this time, and redetermining a speed of the target object relative to the laser detection apparatus and a distance therebetween in the next sweep period.

In another embodiment, after step S108, if the first slope is less than the second slope, the detection method further includes an initial check step for checking initially whether the speed of the target object relative to the laser detection apparatus and the distance therebetween calculated based on the first decoupling algorithm or the second decoupling algorithm are correct, including:

if the first decoupling algorithm is started, determining a distance beat frequency and a speed beat frequency of a first beat frequency signal, and a distance beat frequency and a speed beat frequency of a third beat frequency signal based on the first decoupling algorithm; and

if the distance beat frequency of the first beat frequency signal is greater than or equal to the speed beat frequency, and the distance beat frequency of the third beat frequency signal is greater than or equal to the speed beat frequency, determining that the speed of the target object relative to the laser detection apparatus and the distance therebetween that are determined based on the first coupling algorithm pass a check; otherwise, determining that the speed of the target object relative to the laser detection apparatus and the distance therebetween that are determined based on the first coupling algorithm fail the check, where the first decoupling algorithm can be switched to the second decoupling algorithm at this time; or

if the second decoupling algorithm is started, determining a distance beat frequency and a speed beat frequency of a first beat frequency signal, and a distance beat frequency and a speed beat frequency of a third beat frequency signal based on the second decoupling algorithm; and

if the distance beat frequency of the first beat frequency signal is less than the speed beat frequency, and the distance beat frequency of the third beat frequency signal is less than the speed beat frequency, determining that the speed of the target object relative to the laser detection apparatus and the distance therebetween that are determined based on the second coupling algorithm pass a check; otherwise, determining that the speed of the target object relative to the laser detection apparatus and the distance therebetween that are determined based on the second coupling algorithm fail the check, discarding the speed of the target object relative to the laser detection apparatus and the distance therebetween that are determined in this sweep period at this time, and redetermining a speed of the target object relative to the laser detection apparatus and a distance therebetween in the next sweep period.

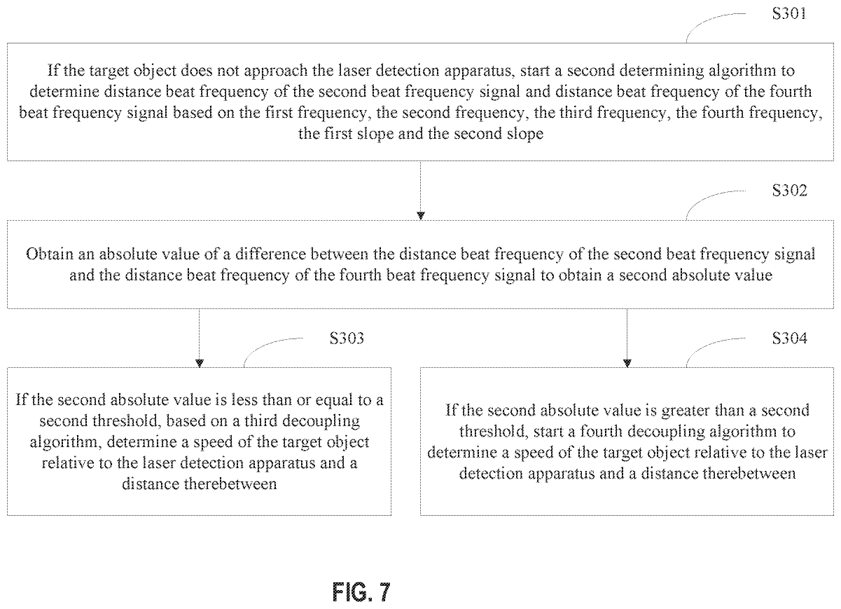

As shown in FIG. 7, in an embodiment, for a situation where the target object does not approach (leaves or is stationary relative to) the laser detection apparatus, step S108 includes the following step S301 to step S404.

Step S301: If the target object does not approach the laser detection apparatus, start a second determining algorithm to determine distance beat frequency of the second beat frequency signal and distance beat frequency of the fourth beat frequency signal based on the first frequency, the second frequency, the third frequency, the fourth frequency, the first slope and the second slope, and go to step S302.

Step S302: Obtain an absolute value of a difference between the distance beat frequency of the second beat frequency signal and the distance beat frequency of the fourth beat frequency signal to obtain a second absolute value, and go to step 303 or step S304.

Step S303: If the second absolute value is less than or equal to a second threshold, based on a third decoupling algorithm, determine a speed of the target object relative to the laser detection apparatus and a distance therebetween.

Step S304: If the second absolute value is greater than a second threshold, start a fourth decoupling algorithm to determine the speed of the target object relative to the laser detection apparatus and a distance therebetween.

The second determining algorithm is configured to: for a scenario in which the target object leaves the laser detection apparatus and the first to the fourth beat frequency signals all satisfy that the distance beat frequency is greater than or equal to speed beat frequency, determine the distance beat frequency of the second beat frequency signal and the distance beat frequency of the fourth beat frequency signal. That is, the first determining algorithm corresponds to a scenario shown in FIG. 4. The third decoupling algorithm is configured to: for a scenario in which the target object leaves the laser detection apparatus and the first to the fourth beat frequency signals all satisfy that the distance beat frequency is greater than or equal to speed beat frequency, calculate the speed of the target object relative to the laser detection apparatus and the distance therebetween. That is, the third decoupling algorithm corresponds to a scenario shown in FIG. 4. The fourth decoupling algorithm is configured to: for a scenario in which the target object leaves the laser detection apparatus and the first to the fourth beat frequency signals all satisfy that the distance beat frequency is less than speed beat frequency, calculate the speed of the target object relative to the laser detection apparatus and the distance therebetween. That is, the fourth decoupling algorithm corresponds to a scenario shown in FIG. 5. As being stationary is a state with zero leaving movement, the foregoing second determining algorithm, third decoupling algorithm, and fourth decoupling algorithm are also applicable to the stationary scenario. That is, the foregoing three algorithms are applicable to the scenario where the target object does not approach the laser detection apparatus.

In an embodiment, in each sweep period, when the signal processing device determines that the moving direction of the target object is not towards the laser detection apparatus, the second determining algorithm is first started to separately calculate the distance beat frequency f_{rd1} of the second beat frequency signal and the distance beat frequency f_{rd2} of the fourth beat frequency signal; and then an absolute value of a difference between the distance beat frequency f_{rd1} of the second beat frequency signal and the distance beat frequency f_{rd2} of the fourth beat frequency signal is calculated, to obtain the second absolute value Δf₂. Because the second determining algorithm is actually used to calculate the distance beat frequency f_{rd1} of the second beat frequency signal and the distance beat frequency f_{rd2} of the fourth beat frequency signal with respect to the scenario in FIG. 4, and then is used to: based on magnitude of the second absolute value Δf₂ and the second threshold f₂, determine whether a magnitude relationship between the distance beat frequency f_{rd1} of the second beat frequency signal and the distance beat frequency f_{rd2} of the fourth beat frequency signal satisfies applicable scenarios of the second determining algorithm and the third decoupling algorithm (that is, the scenarios corresponding to FIG. 4), if the second absolute value Δf₂ is less than or equal to the second threshold f₂, the applicable scenario of the third decoupling algorithm (that is, the scenario corresponding to FIG. 4) is satisfied, and based on the third decoupling algorithm, the speed of the target object relative to the laser detection apparatus and the distance therebetween are calculated; otherwise, it is determined that the magnitude relationship between the distance beat frequency f_{rd1} of the second beat frequency signal and the distance beat frequency f_{rd2} of the fourth beat frequency signal satisfies the applicable scenario of the fourth decoupling algorithm (that is, the scenario corresponding to FIG. 5), and at this time, the speed of the target object relative to the laser detection apparatus and the distance therebetween are calculated based on the fourth decoupling algorithm.

In an embodiment, when applicable scenarios of the second determining algorithm and the third decoupling algorithm are satisfied, the distance beat frequency f_{rd1} of the second beat frequency signal is calculated based on the first frequency f₊₁ and the second frequency f₋₁ obtained at the first sweep time, and the known first slope Kᵤ and second slope K_{d}. A formula for calculating the distance beat frequency f_{rd1} of the second beat frequency signal is as follows:

$${f}_{r d 1} = \frac{{f}_{+ 1} + {f}_{- 1}}{1 + \frac{{K}_{u}}{{K}_{d}}}$$

In an embodiment, when applicable scenarios of the second determining algorithm and the third decoupling algorithm are satisfied, the distance beat frequency f_{rd2} of the fourth beat frequency signal may be calculated based on the third frequency f₋₂ and the fourth frequency f₊₂ obtained at the second sweep time, and the known first slope Kᵤ and second slope K_{d}. In this case, a formula for calculating the distance beat frequency f_{rd2} of the fourth beat frequency signal is as follows:

$${f}_{r d 2} = \frac{{f}_{+ 2} + {f}_{- 2}}{1 + \frac{{K}_{u}}{{K}_{d}}}$$

In another embodiment, when the applicable scenarios of the second determining algorithm and the third decoupling algorithm are satisfied, if a difference between the third frequency f₋₂ obtained at the second sweep time and the second frequency f₋₁ obtained at the first sweep time is equal to a difference f₋2−f₋₁=fᵣᵤ₂−f_{rd1} between the distance beat frequency fᵣᵤ₂ of the third beat frequency signal and the distance beat frequency f_{rd1} of the second beat frequency signal, the distance beat frequency f_{rd2} of the fourth beat frequency signal may also be calculated based on the second frequency f₋₁ obtained at the first sweep time and the third frequency f₋₂ obtained at the second sweep time, and the known first slope Kᵤ and second slope K_{d}. In this case, a formula for calculating the distance beat frequency f_{rd2} of the fourth beat frequency signal is as follows:

$${f}_{r d 2} = \frac{{f}_{- 2} - {f}_{- 1}}{\frac{{K}_{u}}{{K}_{d}} - 1}$$

The two methods for calculating the distance beat frequency f_{rd2} of the fourth beat frequency signal can be selected based on an actual need.

In an embodiment, when the target object is stationary relative to the laser detection apparatus, the distance beat frequency f_{rd1} of the second beat frequency signal is equal to the distance beat frequency f_{rd2} of the fourth beat frequency signal; and when the target object approaches or leaves the laser detection apparatus, the distance beat frequency f_{rd1} of the second beat frequency signal is close to but unequal to the distance beat frequency f_{rd2} of the fourth beat frequency signal, and a difference therebetween is small. The second threshold f₂ can be set to a small value, for example, 0.05 times f_{rd1}, 0.1 times f_{rd1} or 0.15 times f_{rd1} based on the absolute value of the difference between the distance beat frequency f_{rd1} of the second beat frequency signal and the distance beat frequency f_{rd2} of the fourth beat frequency signal. The first threshold can also be set to a small fixed value. The first threshold f₁ may be equal to the second threshold f₂.

The second determining algorithm is used for identifying the scenario by comparing the absolute value of the difference between the distance beat frequency of the second beat frequency signal and the distance beat frequency of the fourth beat frequency signal with the first threshold in the foregoing embodiments, in another embodiment of this application, the second determining algorithm may also be used for identifying the scenario by comparing the absolute value of the difference between the distance beat frequency of the first beat frequency signal and the distance beat frequency of the third beat frequency signal with the first threshold. A specific implementation is similar to the foregoing solution.

In another embodiment, for a situation where the target object does not approach the laser detection apparatus, step S108 includes:

if the target object leaves the laser detection apparatus and the second frequency is less than the fourth frequency, starting a third decoupling algorithm to determine a speed of the target object relative to the laser detection apparatus and a distance therebetween; or

if the target object leaves the laser detection apparatus and the second frequency is greater than the fourth frequency, starting a fourth decoupling algorithm to determine a speed of the target object relative to the laser detection apparatus and a distance therebetween.

An embodiment of this application also provides a simplified method for determining the speed of the target object relative to the laser detection apparatus and the distance therebetween. In some embodiments, in each sweep period, when the signal processing device determines that the moving direction of the target object is towards the laser detection apparatus, a current scenario is first determined based on the magnitude relationship between the second frequency f₋₁ and the fourth frequency f₋₂. In some embodiments, if the second frequency f₋₁ is less than the fourth frequency f₋₂, the applicable scenario of the third decoupling algorithm is satisfied, and based on the third decoupling algorithm, the speed of the target object relative to the laser detection apparatus and the distance there between are calculated; otherwise, it is determined that the applicable scenario of the fourth decoupling algorithm is satisfied, and at this time, the third decoupling algorithm is switched to the fourth decoupling algorithm, and the speed of the target object relative to the laser detection apparatus and the distance there between are calculated based on the fourth decoupling algorithm.

In an embodiment, a step of starting a third decoupling algorithm to determine a speed of the target object relative to the laser detection apparatus and a distance therebetween includes:

based on the first frequency, the second frequency, the first slope and the second slope, determining a first distance between the target object and the laser detection apparatus at the first sweep time. In some embodiments, the distance beat frequency f_{rd1} of the second beat frequency signal may be determined first based on the first frequency f₊₁, the second frequency f₋₁, the first slope Kᵤ and the second slope K_{d} through, for example, the following formula (21). Then based on the distance beat frequency f_{rd1} of the second beat frequency signal and the second slope K_{d}, the first distance r₁ is determined through, for example, the following formula (25). During actual calculation, the first distance r₁ can be calculated directly through the formula (25).

Based on the first frequency, the second frequency, the first slope, the second slope, and central frequency of the first triangular wave signal and/or the second triangular wave signal, a first speed of the target object relative to the laser detection apparatus at the first sweep time is determined. In some embodiments, the distance beat frequency fᵣᵤ₁ of the first beat frequency signal may be determined first based on the first slope Kᵤ, the second slope K_{d}, and the distance beat frequency f_{rd1} of the second beat frequency signal through, for example, the following formula (22).

Then the speed beat frequency fᵥ₁ of the first beat frequency signal and the second beat frequency signal are determined based on the first frequency f₊₁, the second frequency f₋₁, the distance beat frequency fᵣᵤ₁ of the first beat frequency signal, and the distance beat frequency f_{rd1} of the second beat frequency signal through, for example, the following formula (27). Then, based on the speed beat frequency fᵥ₁ of the foregoing first beat frequency signal or second beat frequency signal, and the center frequency f₀₁ of the first triangle wave signal (or the center frequency f₀₂ of the second triangle wave signal, or an average f₀₃ of the center frequency of the first triangle wave signal and the center frequency of the second triangle wave signal), the speed of the target object relative to the laser detection apparatus at the first sweep time is determined through, for example, the following formula (29), where f₀ can be the center frequency of the first triangle wave signal or the center frequency of the second triangle wave signal, or the average of the center frequency of the first triangle wave signal and the center frequency of the second triangle wave signal, that is, one of f₀₁, f₀₂ and f₀₃.

Based on the third frequency, the fourth frequency, the first slope and the second slope, a second distance between the target object and the laser detection apparatus at the second sweep time is determined. In some embodiments, the distance beat frequency f_{rd2} of the fourth beat frequency signal may be determined first based on the third frequency f₊₂, the fourth frequency f₋₂, the first slope Kᵤ and the second slope K_{d} through, for example, the following formula (23). Then based on the distance beat frequency f_{rd2} of the fourth beat frequency signal and the second slope K_{d}, the second distance r₂ is determined through, for example, the following formula (26). During actual calculation, the first distance r₂ can be calculated directly through the formula (26).

Based on the third frequency, the fourth frequency, the first slope, the second slope, and central frequency of the first triangular wave signal and/or the second triangular wave signal, a second speed of the target object relative to the laser detection apparatus at the second sweep time is determined. The distance beat frequency fᵣᵤ₂ of the third beat frequency signal may be determined first based on the first slope Kᵤ, the second slope K_{d}, and the distance beat frequency f_{rd2} of the fourth beat frequency signal through, for example, the following formula (24). Then the speed beat frequency fᵥ₂ of the third beat frequency signal and the fourth beat frequency signal are determined based on the third frequency f₊₂, the fourth frequency f₋₂, the distance beat frequency fᵣᵤ₂ of the third beat frequency signal, and the distance beat frequency f_{rd2} of the fourth beat frequency signal through, for example, the following formula (28).

Then, based on the speed beat frequency fᵥ₂ of the foregoing third beat frequency signal or fourth beat frequency signal, and the center frequency f₀₁ of the first triangle wave signal (or the center frequency f₀₁ of the second triangle wave signal, or an average f₀₃ of the center frequency of the first triangle wave signal and the center frequency of the second triangle wave signal), the second speed v₂ of the target object relative to the laser detection apparatus at the first sweep time is determined through, for example, the following formula (30), where f₀ can be the center frequency of the first triangle wave signal or the center frequency of the second triangle wave signal, or the average of the center frequency of the first triangle wave signal and the center frequency of the second triangle wave signal, that is, one of f₀₁, f₀₂ and f₀₃.

In conclusion, in an embodiment, the third algorithm includes but is not limited to the following formula:

$${f}_{r d 1} = \frac{{f}_{+ 1} + {f}_{- 1}}{1 + \frac{{K}_{u}}{{K}_{d}}} = {K}_{d} Δ {t}_{1} \qquad ( 21 )$$

$${f}_{r u 1} = \frac{{K}_{u}}{{K}_{d}} * {f}_{r d 1} \qquad ( 22 )$$

$${f}_{r d 2} = \frac{{f}_{+ 2} + {f}_{- 2}}{1 + \frac{{K}_{u}}{{K}_{d}}} = {K}_{d} Δ {t}_{2} \qquad ( 23 )$$

$${f}_{r u 2} = \frac{{K}_{u}}{{K}_{d}} * {f}_{r d 2} \qquad ( 24 )$$

$${r}_{1} = \frac{c}{2} \frac{{f}_{+ 1} + {f}_{- 1}}{( 1 + \frac{{K}_{u}}{{K}_{d}} ) {K}_{d}} \qquad ( 25 )$$

$${r}_{2} = \frac{c}{2} \frac{{f}_{+ 2} + {f}_{- 2}}{( 1 + \frac{{K}_{u}}{{K}_{d}} ) {K}_{d}} \qquad ( 26 )$$

$${f}_{v 1} = \frac{{f}_{+ 1} - {f}_{- 1} - {f}_{r u 1} + {f}_{r d 1}}{2} \qquad ( 27 )$$

$${f}_{v 2} = \frac{{f}_{+ 2} - {f}_{- 2} + {f}_{r u 2} - {f}_{r d 2}}{2} \qquad ( 28 )$$

$${v}_{1} = \frac{c {f}_{v 1}}{2 {f}_{01}} \qquad ( 29 )$$

$${v}_{2} = \frac{c {f}_{v 2}}{2 {f}_{02}} \qquad ( 30 )$$

where f₊₁ represents the first frequency, f₋₁ represents the second frequency, f_{rd1} represents the distance beat frequency of the second beat frequency signal, fᵣᵤ₁ represents the distance beat frequency of the first beat frequency signal, Kᵤ represents the first slope, K_{d} represents the second slope, Δt₁ represents time of flight of a first lower-sweep detection signal, f₊₂ represents the third frequency, f₋₂ represents the fourth frequency, f_{rd2} represents the distance beat frequency of the fourth beat frequency signal, Δt₂ represents time of flight of a second upper-sweep detection signal, fᵣᵤ₂ represents the distance beat frequency of the third beat frequency signal, r₁ represents the first distance, c represents a propagation speed of light in the air, r₂ represents the second distance, fᵥ₁ represents the speed beat frequency of the first beat frequency signal and the second beat frequency signal, fᵥ₂ represents the speed beat frequency of the third beat frequency signal and the fourth beat frequency signal, v₁ represents the first speed, v₂ represents the second speed, and f₀ represents the central frequency of the first triangular wave signal or the second triangular wave signal, or represents an average of the central frequency of the first triangular wave signal and the central frequency of the second triangle wave signal.

In an embodiment, a step of starting a fourth decoupling algorithm to determine a speed of the target object relative to the laser detection apparatus and a distance therebetween includes:

based on the first frequency, the second frequency, the first slope, and the second slope, determining a first distance between the target object and the laser detection apparatus at the first sweep time. In some embodiments, the distance beat frequency f_{rd1} of the second beat frequency signal may be determined first based on the first frequency f₊₁, the second frequency f₋₁, the first slope Kᵤ, and the second slope K_{d} through, for example, the following formula (31). Then based on the distance beat frequency f_{rd1} of the second beat frequency signal and the second slope K_{d}, the first distance r₁ is determined through, for example, the following formula (35). During actual calculation, the first distance r₁ can be calculated directly through the formula (35).

Based on the first frequency, the second frequency, the first slope, the second slope, and central frequency of the first triangular wave signal and/or the second triangular wave signal, a first speed of the target object relative to the laser detection apparatus at the first sweep time is determined. The distance beat frequency fᵣᵤ₁ of the first beat frequency signal may be determined first based on the first slope Kᵤ, the second slope K_{d}, and the distance beat frequency f_{rd1} of the second beat frequency signal through, for example, the following formula (32). Then the speed beat frequency fᵥ₁ of the first beat frequency signal and the second beat frequency signal are determined based on the first frequency f₊₁, the second frequency f₋₁, the distance beat frequency fᵣᵤ₁ of the first beat frequency signal, and the distance beat frequency f_{rd1} of the second beat frequency signal through, for example, the following formula (37).

Then, based on the speed beat frequency fᵥ₁ of the foregoing first beat frequency signal or second beat frequency signal, and the center frequency f₀₁ of the first triangle wave signal (or the center frequency f₀₂ of the second triangle wave signal, or an average f₀₃ of the center frequency of the first triangle wave signal and the center frequency of the second triangle wave signal), the speed of the target object relative to the laser detection apparatus at the first sweep time is determined through, for example, the following formula (39), where f₀ can be the center frequency of the first triangle wave signal or the center frequency of the second triangle wave signal, or the average of the center frequency of the first triangle wave signal and the center frequency of the second triangle wave signal, that is, one of f₀₁, f₀₂, and f₀₃.

Based on the third frequency, the fourth frequency, the first slope and the second slope, a second distance between the target object and the laser detection apparatus at the second sweep time is determined. The distance beat frequency f_{rd2} of the fourth beat frequency signal may be determined first based on the third frequency f₊₂, the fourth frequency f₋₂, the first slope Kᵤ and the second slope K_{d} through, for example, the following formula (33). Then based on the distance beat frequency f_{rd2} of the fourth beat frequency signal and the second slope K_{d}, the second distance r₂ is determined through, for example, the following formula (36). During actual calculation, the first distance r₂ can be calculated directly through the formula (36).

Based on the third frequency, the fourth frequency, the first slope, the second slope, and central frequency of the first triangular wave signal and/or the second triangular wave signal, a second speed of the target object relative to the laser detection apparatus at the second sweep time is determined. The distance beat frequency fᵣᵤ₂ of the third beat frequency signal may be determined first based on the first slope Kᵤ, the second slope K_{d}, and the distance beat frequency f_{rd2} of the fourth beat frequency signal through, for example, the following formula (34). Then the speed beat frequency fᵥ₂ of the third beat frequency signal and the fourth beat frequency signal are determined based on the third frequency f₊₂, the fourth frequency f₋₂, the distance beat frequency fᵣᵤ₂ of the third beat frequency signal, and the distance beat frequency f_{rd2} of the fourth beat frequency signal through, for example, the following formula (38).

Then, based on the speed beat frequency fᵥ₂ of the foregoing third beat frequency signal or fourth beat frequency signal, and the center frequency f₀₁ of the first triangle wave signal (or the center frequency f₀₁ of the second triangle wave signal, or an average f₀₃ of the center frequency of the first triangle wave signal and the center frequency of the second triangle wave signal), the second speed v₂ of the target object relative to the laser detection apparatus at the first sweep time is determined through, for example, the following formula (30), where f₀ can be the center frequency of the first triangle wave signal or the center frequency of the second triangle wave signal, or the average of the center frequency of the first triangle wave signal and the center frequency of the second triangle wave signal, that is, one of f₀₁, f₀₂ and f₀₃.

The fourth decoupling algorithm includes but is not limited to the following formulas:

$${f}_{r d 1} = \frac{{f}_{+ 1} - {f}_{- 1}}{1 + \frac{{K}_{u}}{{K}_{d}}} = {K}_{d} Δ {t}_{1} \qquad ( 31 )$$

$${f}_{r u 1} = \frac{{K}_{u}}{{K}_{d}} * {f}_{r d 1} \qquad ( 32 )$$

$${f}_{r d 2} = \frac{{f}_{+ 2} - {f}_{- 2}}{1 + \frac{{K}_{u}}{{K}_{d}}} = {K}_{d} Δ {t}_{2} \qquad ( 33 )$$

$${f}_{r u 2} = \frac{{K}_{u}}{{K}_{d}} * {f}_{r d 2} \qquad ( 34 )$$

$${r}_{1} = \frac{c}{2} \frac{{f}_{+ 1} - {f}_{- 1}}{( 1 + \frac{{K}_{u}}{{K}_{d}} ) {K}_{d}} \qquad ( 35 )$$

$${r}_{2} = \frac{c}{2} \frac{{f}_{+ 2} - {f}_{- 2}}{( 1 + \frac{{K}_{u}}{{K}_{d}} ) {K}_{d}} \qquad ( 36 )$$

$${f}_{v 1} = \frac{{f}_{+ 1} + {f}_{- 1} - {f}_{r u 1} + {f}_{r d 1}}{2} \qquad ( 37 )$$

$${f}_{v 2} = \frac{{f}_{+ 2} + {f}_{- 2} + {f}_{r u 2} - {f}_{r d 2}}{2} \qquad ( 38 )$$

$${v}_{1} = \frac{c {f}_{ν 1}}{2 {f}_{01}} \qquad ( 39 )$$

$${v}_{2} = \frac{c {f}_{v 2}}{2 {f}_{02}} \qquad ( 40 )$$

where f₊₁ represents the first frequency, f₋₁ represents the second frequency, f_{rd1} represents the distance beat frequency of the second beat frequency signal, fᵣᵤ₁ represents the distance beat frequency of the first beat frequency signal, Kᵤ represents the first slope, K_{d} represents the second slope, Δt₁ represents time of flight of a first lower-sweep detection signal, f₊₂ represents the third frequency, f₋₂ represents the fourth frequency, f_{rd2} represents the distance beat frequency of the fourth beat frequency signal, Δt₂ represents time of flight of a second upper-sweep detection signal, fᵣᵤ₂ represents the distance beat frequency of the third beat frequency signal, r₁ represents the first distance, c represents a propagation speed of light in the air, r₂ represents the second distance, fᵥ₁ represents the speed beat frequency of the first beat frequency signal and the second beat frequency signal, fᵥ₂ represents the speed beat frequency of the third beat frequency signal and the fourth beat frequency signal, v₁ represents the first speed, v₂ represents the second speed, and f₀ represents the central frequency of the first triangular wave signal or the second triangular wave signal, or represents an average of the central frequency of the first triangular wave signal and the central frequency of the second triangle wave signal.

In an embodiment, for the scenario where the target object leaves the laser detection apparatus, if the first slope is greater than the second slope, the detection method further includes an initial check step for checking initially whether the speed of the target object relative to the laser detection apparatus and the distance therebetween calculated based on the third algorithm or the fourth algorithm are correct, including:

if the third decoupling algorithm is started, determining a distance beat frequency and a speed beat frequency of a second beat frequency signal, and a distance beat frequency and a speed beat frequency of a fourth beat frequency signal based on the third decoupling algorithm, where the step can be performed during or after step S108; and

if the distance beat frequency of the second beat frequency signal is greater than or equal to the speed beat frequency, and the distance beat frequency of the fourth beat frequency signal is greater than or equal to the speed beat frequency, determining that the speed of the target object relative to the laser detection apparatus and the distance therebetween that are determined based on the third coupling algorithm pass a check; otherwise, determining that the speed of the target object relative to the laser detection apparatus and the distance therebetween that are determined based on the third coupling algorithm fail the check, where the third decoupling algorithm can be switched to the fourth decoupling algorithm at this time; or

if the fourth decoupling algorithm is started, determining a distance beat frequency and a speed beat frequency of a second beat frequency signal, and a distance beat frequency and a speed beat frequency of a fourth beat frequency signal based on the fourth decoupling algorithm, where the step can be performed during or after step S108; and

if the distance beat frequency of the second beat frequency signal is less than the speed beat frequency, and the distance beat frequency of the fourth beat frequency signal is less than the speed beat frequency, determining that the speed of the target object relative to the laser detection apparatus and the distance therebetween that are determined based on the fourth coupling algorithm pass a check; otherwise, determining that the speed of the target object relative to the laser detection apparatus and the distance therebetween that are determined based on the fourth coupling algorithm fail the check, discarding the speed of the target object relative to the laser detection apparatus and the distance therebetween that are determined in this sweep period at this time, and redetermining a speed of the target object relative to the laser detection apparatus and a distance therebetween in the next sweep period.

In another embodiment, after step S108, for the scenario where the target object leaves the laser detection apparatus, if the first slope is less than the second slope, the detection method further includes an initial check step for checking initially whether the speed of the target object relative to the laser detection apparatus and the distance therebetween calculated based on the third algorithm or the fourth algorithm are correct, including:

if the third decoupling algorithm is started, determining a distance beat frequency and a speed beat frequency of a first beat frequency signal, and a distance beat frequency and a speed beat frequency of a third beat frequency signal based on the third decoupling algorithm; and

if the distance beat frequency of the first beat frequency signal is greater than or equal to the speed beat frequency, and the distance beat frequency of the third beat frequency signal is greater than or equal to the speed beat frequency, determining that the speed of the target object relative to the laser detection apparatus and the distance therebetween that are determined based on the third coupling algorithm pass a check; otherwise, determining that the speed of the target object relative to the laser detection apparatus and the distance therebetween that are determined based on the third coupling algorithm fail the check, where the third decoupling algorithm can be switched to the fourth decoupling algorithm at this time; or

if the fourth algorithm is started, determining a distance beat frequency and a speed beat frequency of a first beat frequency signal, and a distance beat frequency and a speed beat frequency of a third beat frequency signal based on the fourth decoupling algorithm; and

if the distance beat frequency of the first beat frequency signal is less than the speed beat frequency, and the distance beat frequency of the third beat frequency signal is less than the speed beat frequency, determining that the speed of the target object relative to the laser detection apparatus and the distance therebetween that are determined based on the fourth coupling algorithm pass a check; otherwise, determining that the speed of the target object relative to the laser detection apparatus and the distance therebetween that are determined based on the fourth coupling algorithm fail the check, discarding the speed of the target object relative to the laser detection apparatus and the distance therebetween that are determined in this sweep period at this time, and redetermining a speed of the target object relative to the laser detection apparatus and a distance therebetween in the next sweep period.

When the target object is relatively close to the laser detection apparatus, it is more likely that the foregoing first to fourth beat frequency signals all satisfy the scenario where the distance beat frequency is less than the speed beat frequency, that is, the foregoing scenarios in FIG. 3 and FIG. 5, and therefore, the distance threshold is set in this application to further check whether the foregoing scenario is satisfied. Therefore, in an embodiment, after successful passing of the initial check of the second decoupling algorithm and the fourth decoupling algorithm, the detection method further includes a check step for further checking whether the relative distance between the target object and the laser detection apparatus is correct, including:

checking whether the first distance r₁ is greater than a first distance threshold L₁ and less than or equal to a second distance threshold L₂; and

if yes (that is, L₁<r₁≤L₂), determining that the first distance is correct; or

if no (that is, r₁≤L₁ or r₁>L₂), determining that the first distance is incorrect; or

checking whether the second distance r₂ is greater than the first distance threshold L₁ and less than or equal to the second distance threshold L₂; and

if yes (that is, L₁<r₂≤L₂), determining that the second distance is correct; or

if no (that is, r₂≤L₁ or r₂>L₂), determining that the second distance is incorrect.

In an embodiment, the first distance threshold L₁ may be a lower ranging limit of the laser detection apparatus; and for example, if the lower ranging limit of the laser detection apparatus is 0.05 m, 0.1 m or 0.2 m, the first distance threshold L₁ may be 0.05 m, 0.1 m or 0.2 m. The second distance threshold L₂ can be a distance set empirically. When the first distance or the second distance is less than the second threshold, the speed beat frequency of the target object is likely to be greater than the distance beat frequency; and the second distance threshold L₂ can be a threshold set empirically, for example, 20 m, 40 m or 50 m. The foregoing method can also be simplified to only check whether the first distance r₁ is less than or equal to the second distance threshold L₂, and/or check whether the second distance r₂ is less than or equal to the second distance threshold L₂.

In addition, in an embodiment, after successful passing of the initial check of any one of the first decoupling algorithm to the fourth decoupling algorithm, the detection method further includes a step for further checking whether the speed of the target object relative to the laser detection apparatus falls into a detectable range or a proper range, where the step includes:

checking whether the speed beat frequency fᵥ₁ of the second beat frequency signal is less than or equal to the first speed beat frequency threshold F₁;

if yes (that is, fᵥ₁≤F₁), further checking whether the first speed v₁ is less than or equal to the first speed threshold V₁; and

if yes (that is, v₁≤V₁), determining that the first speed v₁ is correct; or

if no (that is, v₁>V₁), determining that the first speed v₁ is incorrect; or

checking whether the speed beat frequency fᵥ₂ of the fourth beat frequency signal is less than or equal to the second speed beat frequency threshold F₂;

if yes (that is, fᵥ₂≤F₂), further checking whether the second speed v₂ is less than or equal to the second speed threshold V₂; otherwise, determining that the second speed v₂ is incorrect; and

if yes (that is, v₂≤V₂), determining that the second speed v₂ is correct; or

if no (that is, v₂>V₂), determining that the second speed v₂ is incorrect.

In an embodiment, the first speed beat frequency threshold F₁, the second speed beat frequency threshold F₂, the first speed threshold V₁, and the second speed threshold V₂ can be set based on an actual need. For example, F₁ and F₂ are 50 MHz, and V₁ and V₂ are 120 Km/h or 150 Km/h.

A sequence number of each step in the foregoing embodiments does not mean an execution sequence. An execution sequence of each process should be determined based on a function and internal logic of each process, and should not constitute any limitation to an implementation process of the embodiments of this application.

An embodiment of this application also provides a laser detection apparatus, configured to perform the steps in the foregoing detection method embodiments. The laser detection apparatus may be a virtual appliance in laser detection apparatuses that is run by a processor of the laser detection apparatus, or may be the laser detection apparatus itself.

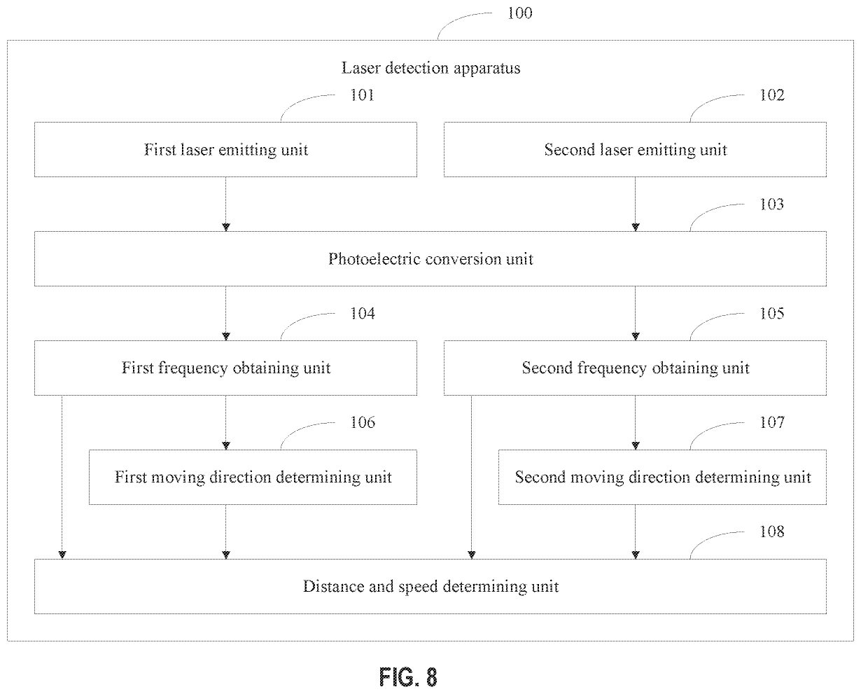

As shown in FIG. 8, the laser detection apparatus 100 provided in this embodiment of this application includes:

a first laser emission unit 101, configured to control a first laser to generate a first triangular wave signal in each sweep period, and proceed to a photoelectric conversion unit 103;

a second laser emission unit 102, configured to control a second laser to generate a second triangular wave signal in each sweep period, and proceed to a photoelectric conversion unit 103;

a photoelectric conversion unit 103, configured to control a photoelectric detection module to receive a first local oscillator signal, an echo signal of a first detection signal, a second local oscillator signal and an echo signal of a second detection signal, and proceed to a first frequency obtaining unit 104 and a second frequency obtaining unit 105.

a first frequency obtaining unit 104, configured to obtain first frequency and second frequency at the first sweep time, and proceed to a first moving direction determining unit 106 and a distance and speed determining unit 108;

a second frequency obtaining unit 105, configured to obtain third frequency and fourth frequency at the second sweep time, and proceed to a second moving direction determining unit 107 and a distance and speed determining unit 108;

a first moving direction determining unit 106, configured to: based on a magnitude relationship between the first power and the second power and a magnitude relationship between amplitudes of the first frequency and the second frequency, determine a moving direction of a target object relative to the laser detection apparatus at the first sweep time, and proceed to a distance and speed determining unit 108;

a second moving direction determining unit 107, configured to: based on a magnitude relationship between the first power and the second power and a magnitude relationship between amplitudes of the third frequency and the fourth frequency, determine a moving direction of a target object relative to the laser detection apparatus at the second sweep time, and proceed to a distance and speed determining unit 108; and

a distance and speed determining unit 108, configured to: based on the moving direction, the first frequency, the second frequency, the third frequency, the fourth frequency, the first slope, the second slope, and central frequency of the first triangular wave signal and/or the second triangular wave signal, determine a speed of the target object relative to the laser detection apparatus and a distance therebetween.

In an embodiment, the laser detection apparatus further includes a check unit, configured to perform the check steps in the foregoing detection method embodiments.

In an embodiment, units in the laser detection apparatus may be software program units, or may be implemented by different logic circuits integrated in a processor, or may be implemented by more than two distributed processors.

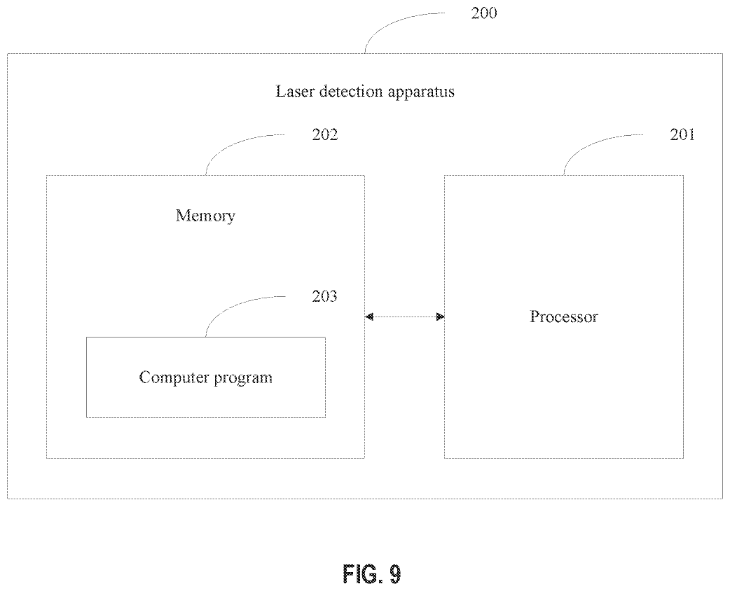

As shown in FIG. 9, an embodiment of this application also provides a laser detection apparatus 200, including: at least one processor 201 (only one processor is shown in FIG. 9), a memory 202, and a computer program 203 stored in the memory 202 and capable of running on the at least one processor 201, where when the processor 201 executes the computer program 203, the steps in the foregoing detection method embodiments are implemented.

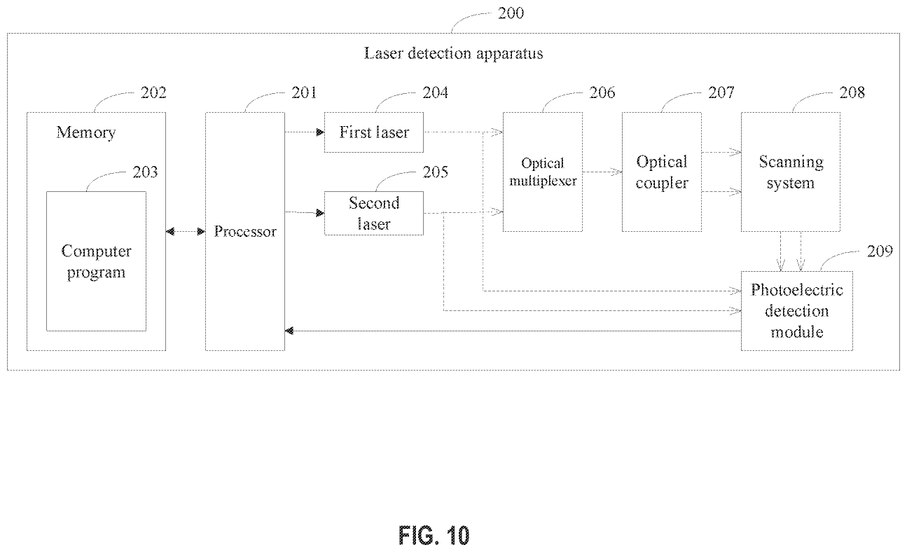

As shown in FIG. 10, in an embodiment, the laser detection apparatus 200 further includes: a first laser 204, a second laser 205, an optical multiplexer 206, a scanning system 207, an optical coupler 208 and a photoelectric detection module 209.

The processor 201 is connected to the first laser 205, the second laser 206 and the photoelectric detection module 208 respectively.

FIG. 10 shows a schematic structural diagram of a laser detection apparatus, where two lasers share the same set of transceiving optical circuits, which can effectively reduce volume and save costs.

In an embodiment, the laser detection apparatus may include, but not limited to, a memory and a processor, and may also include a first laser, a second laser, an optical multiplexer, an optical coupler, a scanning system, a photoelectric detection module, and the like, for example, the laser detection apparatus shown in FIG. 10. A person skilled in the art can understand that FIG. 9 and FIG. 10 are only examples of the laser detection apparatus, and does not constitute a limitation on the laser detection apparatus. The laser detection apparatus may include more or fewer components than those shown in the figure, or a combination of some components, or different components.

Content such as information exchange and an execution process between the foregoing apparatuses or units is based on the same concept as the method embodiments of this application. For specific functions and technical effects thereof, reference may be made to the method embodiments.

Division of the foregoing functional units is taken as an example for illustration. In actual application, the foregoing functions can be allocated to different units and implemented according to a requirement, that is, an inner structure of an apparatus is divided into different functional units to implement all or part of the functions described above. The functional units in the embodiments may be integrated into one processing unit, or each unit may exist alone physically, or two or more units may be integrated into one unit. The integrated unit may be implemented in a form of hardware, or may be implemented in a form of a software functional unit. In addition, specific names of the functional units are only for the convenience of distinguishing one another, and are not intended to limit the protection scope of this application. For a detailed working process of units in the foregoing system, reference may be made to a corresponding process in the foregoing method embodiments.

According to the embodiments of this application, a computer-readable storage medium is provided, where the computer-readable storage medium stores a computer program, and when the computer program is executed by a processor, a detection method of any foregoing embodiment is implemented.

An embodiment of this application provides a computer program product, where when the computer program product runs on a laser detection apparatus, the laser detection apparatus performs the detection method in any one of the foregoing embodiments.

When the integrated unit is implemented in the form of a software functional unit and sold or used as an independent product, the integrated unit may be stored in a computer-readable storage medium. Based on such understanding, some or all of the processes for implementing the methods in the embodiments of this application may be completed by related hardware instructed by a computer program. The computer program may be stored in a computer-readable storage medium. When the computer program is executed by the processor, the steps of the foregoing method embodiments are implemented. The computer program includes computer program code, and the computer program code may be in a form of source code, object code, or an executable file, intermediate forms, or the like. The computer-readable medium may at least include: any entity or apparatus capable of loading the computer program code onto a laser detection apparatus, a recording medium, a computer memory, a read-only memory (ROM), a random access memory (RAM), an electrical carrier signal, a telecommunications signal, and a software distribution medium. The computer-readable medium is, for example, a USB flash drive, a removable hard disk, a magnetic disk, or an optical disc.

In the foregoing embodiments, the descriptions of the embodiments have respective focuses. For a part that is not described in detail in one embodiment, reference may be made to related descriptions in other embodiments.

In the embodiments provided in this application, it should be understood that the disclosed apparatus, laser detection apparatus and method may be implemented in other methods. For example, the embodiments of the described apparatus and laser detection apparatus are merely examples. For example, division of the unit is merely logical function division and may be other division methods in actual implementation. For example, more than two units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

What is claimed is:

1. A detection method of a laser detection apparatus, comprising:
controlling a first laser to generate a first triangular wave signal in each sweep period, wherein emission power of the first laser is first power, a sweep slope of the first triangular wave signal is a first slope, and the sweep period comprises first sweep time and second sweep time connected in sequence;
controlling a second laser to generate a second triangular wave signal in each sweep period, wherein emission power of the second laser is second power different from the first power, a sweep slope of the second triangular wave signal is second slope, and the second slope is different from the first slope;
controlling a photoelectric detection module to receive a first local oscillator signal, an echo signal of a first detection signal, a second local oscillator signal, and an echo signal of a second detection signal, wherein the first local oscillator signal and the first detection signal are two signals formed via beam splitting of the first triangular wave signal, the first local oscillator signal comprises a first upper-sweep local oscillator signal at the first sweep time and a second lower-sweep local oscillator signal at the second sweep time, the first detection signal comprises a first upper-sweep detection signal at the first sweep time and a second lower-sweep detection signal at the second sweep time, the second local oscillator signal and the second detection signal are two signals formed via beam splitting of the second triangular wave signal, the second local oscillator signal comprises a first lower-sweep local oscillator signal at the first sweep time and a second upper-sweep local oscillator signal at the second sweep time, and the second detection signal comprises a first lower-sweep detection signal at the first sweep time and a second upper-sweep detection signal at the second sweep time;
obtaining first frequency and second frequency at the first sweep time, wherein the first frequency is a higher one of frequency of a first beat frequency signal and frequency of a second beat frequency signal, the second frequency is a lower one of the frequency of the first beat frequency signal and the frequency of the second beat frequency signal, the first beat frequency signal is a beat frequency signal of the first upper-sweep local oscillator signal and an echo signal of the first upper-sweep detection signal, and the second beat frequency signal is a beat frequency signal of the first lower-sweep local oscillator signal and an echo signal of the first lower-sweep detection signal;
obtaining third frequency and fourth frequency at the second sweep time, wherein the third frequency is a higher one of frequency of a third beat frequency signal and frequency of a fourth beat frequency signal, the fourth frequency is a lower one of the frequency of the third beat frequency signal and the frequency of the fourth beat frequency signal, the third beat frequency signal is a beat frequency signal of the second lower-sweep local oscillator signal and an echo signal of the second lower-sweep detection signal, and the fourth beat frequency signal is a beat frequency signal of the second upper-sweep local oscillator signal and an echo signal of the second upper-sweep detection signal;
based on a magnitude relationship between the first power and the second power and a magnitude relationship between amplitudes of the first frequency and the second frequency, determining a moving direction of a target object relative to the laser detection apparatus at the first sweep time; or based on a magnitude relationship between the first power and the second power and a magnitude relationship between amplitudes of the third frequency and the fourth frequency, determining a moving direction of a target object relative to the laser detection apparatus at the second sweep time; and
based on the moving direction, the first frequency, the second frequency, the third frequency, the fourth frequency, the first slope, the second slope, and central frequency of the first triangular wave signal or the second triangular wave signal, determining a speed of the target object relative to the laser detection apparatus and a distance therebetween.

2. The detection method according to claim 1, wherein based on the magnitude relationship between the first power and the second power and the magnitude relationship between amplitudes of the first frequency and the second frequency, the determining the moving direction of the target object relative to the laser detection apparatus at the first sweep time comprises:
if the first power is greater than the second power and the amplitude of the first frequency is less than the amplitude of the second frequency, determining that the target object approaches the laser detection apparatus at the first sweep time; or if the amplitude of the first frequency is greater than the amplitude of the second frequency, determining that the target object does not approach the laser detection apparatus at the first sweep time; or
if the first power is less than the second power and the amplitude of the first frequency is greater than the amplitude of the second frequency, determining that the target object approaches the laser detection apparatus at the first sweep time; or if the amplitude of the first frequency is less than the amplitude of the second frequency, determining that the target object does not approach the laser detection apparatus at the first sweep time,
wherein based on the magnitude relationship between the first power and the second power and the magnitude relationship between amplitudes of the third frequency and the fourth frequency, the determining the moving direction of the target object relative to the laser detection apparatus at the second sweep time comprises:
if the first power is greater than the second power and the amplitude of the third frequency is greater than the amplitude of the fourth frequency, determining that the target object approaches the laser detection apparatus at the second sweep time; or if the amplitude of the third frequency is less than the amplitude of the fourth frequency, determining that the target object does not approach the laser detection apparatus at the second sweep time; or
if the first power is less than the second power and the amplitude of the third frequency is less than the amplitude of the fourth frequency, determining that the target object approaches the laser detection apparatus at the second sweep time; or if the amplitude of the third frequency is greater than the amplitude of the fourth frequency, determining that the target object does not approach the laser detection apparatus at the second sweep time.

3. The detection method according to claim 1, wherein based on the moving direction, the first frequency, the second frequency, the third frequency, the fourth frequency, the first slope, the second slope, and central frequency of the first triangular wave signal or the second triangular wave signal, the determining the speed of the target object relative to the laser detection apparatus and the distance therebetween comprise:
if the target object approaches the laser detection apparatus, starting a first determining algorithm to determine distance beat frequency of the second beat frequency signal and distance beat frequency of the fourth beat frequency signal based on the first frequency, the second frequency, the third frequency, the fourth frequency, the first slope and the second slope;
obtaining an absolute value of a difference between the distance beat frequency of the second beat frequency signal and the distance beat frequency of the fourth beat frequency signal to obtain a first absolute value; and
if the first absolute value is less than or equal to a first threshold, starting a first decoupling algorithm to determine a speed of the target object relative to the laser detection apparatus and a distance therebetween; or
if the first absolute value is greater than a first threshold, starting a second decoupling algorithm to determine a speed of the target object relative to the laser detection apparatus and a distance therebetween, wherein
the first determining algorithm is configured to: for a scenario in which the target object approaches the laser detection apparatus and the first beat frequency signal to the fourth beat frequency signal all satisfy that the distance beat frequency is greater than or equal to speed beat frequency, determine the distance beat frequency of the second beat frequency signal and the distance beat frequency of the fourth beat frequency signal;
the first decoupling algorithm is configured to: for a scenario in which the target object approaches the laser detection apparatus and the first beat frequency signal to the fourth beat frequency signal all satisfy that the distance beat frequency is greater than or equal to speed beat frequency, calculate the speed of the target object relative to the laser detection apparatus and the distance therebetween; and
the second decoupling algorithm is configured to: for a scenario in which the target object approaches the laser detection apparatus and the first beat frequency signal to the fourth beat frequency signal all satisfy that the distance beat frequency is less than speed beat frequency, calculate the speed of the target object relative to the laser detection apparatus and the distance therebetween.

4. The detection method according to claim 1, wherein based on the moving direction, the first frequency, the second frequency, the third frequency, the fourth frequency, the first slope, the second slope, and central frequency of the first triangular wave signal or the second triangular wave signal, the determining the speed of the target object relative to the laser detection apparatus and the distance therebetween comprise:
if the target object approaches the laser detection apparatus, starting a first determining algorithm to determine distance beat frequency of the first beat frequency signal and distance beat frequency of the third beat frequency signal based on the first frequency, the second frequency, the third frequency, the fourth frequency, the first slope and the second slope;
obtaining an absolute value of a difference between the distance beat frequency of the first beat frequency signal and the distance beat frequency of the third beat frequency signal to obtain a first absolute value; and
if the first absolute value is less than or equal to a first threshold, starting a first decoupling algorithm to determine a speed of the target object relative to the laser detection apparatus and a distance therebetween; or
if the first absolute value is greater than a first threshold, starting a second decoupling algorithm to determine a speed of the target object relative to the laser detection apparatus and a distance therebetween, wherein
the first determining algorithm is configured to: for a scenario in which the target object approaches the laser detection apparatus and the first beat frequency signal to the fourth beat frequency signal all satisfy that the distance beat frequency is greater than or equal to speed beat frequency, determine the distance beat frequency of the second beat frequency signal and the distance beat frequency of the fourth beat frequency signal;
the first decoupling algorithm is configured to: for a scenario in which the target object approaches the laser detection apparatus and the first beat frequency signal to the fourth beat frequency signal all satisfy that the distance beat frequency is greater than or equal to speed beat frequency, calculate the speed of the target object relative to the laser detection apparatus and the distance therebetween; and
the second decoupling algorithm is configured to: for a scenario in which the target object approaches the laser detection apparatus and the first beat frequency signal to the fourth beat frequency signal all satisfy that the distance beat frequency is less than speed beat frequency, calculate the speed of the target object relative to the laser detection apparatus and the distance therebetween.

5. The detection method according to claim 1, wherein based on the moving direction, the first frequency, the second frequency, the third frequency, the fourth frequency, the first slope, the second slope, and central frequency of the first triangular wave signal or the second triangular wave signal, the determining the speed of the target object relative to the laser detection apparatus and the distance therebetween comprise:
if the target object approaches the laser detection apparatus and the second frequency is greater than the fourth frequency, starting a first decoupling algorithm to determine a speed of the target object relative to the laser detection apparatus and a distance therebetween; or
if the target object approaches the laser detection apparatus and the second frequency is less than the fourth frequency, starting a second decoupling algorithm to determine a speed of the target object relative to the laser detection apparatus and a distance therebetween, wherein
the first decoupling algorithm is configured to: for a scenario in which the target object approaches the laser detection apparatus and the first beat frequency signal to the fourth beat frequency signal all satisfy that distance beat frequency is greater than or equal to speed beat frequency, calculate the speed of the target object relative to the laser detection apparatus and the distance therebetween; and
the second decoupling algorithm is configured to: for a scenario in which the target object approaches the laser detection apparatus and the first beat frequency signal to the fourth beat frequency signal all satisfy that the distance beat frequency is less than speed beat frequency, calculate the speed of the target object relative to the laser detection apparatus and the distance therebetween.

6. The detection method according to claim 3, wherein
if the first slope is greater than the second slope, the method further comprises:
if the first decoupling algorithm is started, determining a speed beat frequency of the second beat frequency signal and a speed beat frequency of the fourth beat frequency signal based on the first decoupling algorithm; and
if the distance beat frequency of the second beat frequency signal is greater than or equal to the speed beat frequency, and the distance beat frequency of the fourth beat frequency signal is greater than or equal to the speed beat frequency, determining that the speed of the target object relative to the laser detection apparatus and the distance therebetween that are determined based on the first coupling algorithm pass a check,
if the first slope is greater than the second slope, the method further comprises:
if the second decoupling algorithm is started, determining a speed beat frequency of the second beat frequency signal and a speed beat frequency of the fourth beat frequency signal based on the second decoupling algorithm; and
if the distance beat frequency of the second beat frequency signal is less than the speed beat frequency, and the distance beat frequency of the fourth beat frequency signal is less than the speed beat frequency, determining that the speed of the target object relative to the laser detection apparatus and the distance therebetween that are determined based on the second coupling algorithm pass a check.

7. The detection method according to claim 3, wherein the starting the first decoupling algorithm to determine the speed of the target object relative to the laser detection apparatus and the distance therebetween, and the starting the second decoupling algorithm to determine the speed of the target object relative to the laser detection apparatus and the distance therebetween both comprise:
based on the first frequency, the second frequency, the first slope, and the second slope, determining a first distance between the target object and the laser detection apparatus at the first sweep time;
based on the first frequency, the second frequency, the first slope, the second slope, and central frequency of the first triangular wave signal or the second triangular wave signal, determining a first speed of the target object relative to the laser detection apparatus at the first sweep time;
based on the third frequency, the fourth frequency, the first slope, and the second slope, determining a second distance between the target object and the laser detection apparatus at the second sweep time; and
based on the third frequency, the fourth frequency, the first slope, the second slope, and central frequency of the first triangular wave signal or the second triangular wave signal, determining a second speed of the target object relative to the laser detection apparatus at the second sweep time.

8. The detection method according to claim 7, wherein the first decoupling algorithm comprises the following formulas:
$${f}_{r d 1} = \frac{{f}_{+ 1} + {f}_{- 1}}{1 + \frac{{K}_{u}}{{K}_{d}}}$$
$${f}_{ru 1} = \frac{{K}_{u}}{{K}_{d}} * {f}_{r d 1}$$
$${f}_{r d 2} = \frac{{f}_{+ 2} + {f}_{- 2}}{1 + \frac{{K}_{u}}{{K}_{d}}}$$
$${f}_{ru 2} = \frac{{K}_{u}}{{K}_{d}} * {f}_{r d 2}$$
$${r}_{1} = \frac{c}{2} \frac{{f}_{+ 1} + {f}_{- 1}}{( 1 + \frac{{K}_{u}}{{K}_{d}} ) {K}_{d}}$$
$${r}_{2} = \frac{c}{2} \frac{{f}_{+ 2} + {f}_{- 2}}{( 1 + \frac{{K}_{u}}{{K}_{d}} ) {K}_{d}}$$
$${f}_{v 1} = \frac{{f}_{+ 1} - {f}_{- 1} + {f}_{r u 1} - {f}_{r d 1}}{2}$$
$${f}_{v 2} = \frac{{f}_{+ 2} - {f}_{- 2} - {f}_{r u 2} + {f}_{r d 2}}{2}$$
$${v}_{1} = \frac{c {f}_{v 1}}{2 {f}_{0}}$$
$${v}_{2} = \frac{c {f}_{v 2}}{2 {f}_{0}}$$
the second decoupling algorithm comprises the following formulas:
$${f}_{r d 1} = \frac{{f}_{+ 1} - {f}_{- 1}}{1 + \frac{{K}_{u}}{{K}_{d}}}$$
$${f}_{ru 1} = \frac{{K}_{u}}{{K}_{d}} * {f}_{r d 1}$$
$${f}_{r d 2} = \frac{{f}_{+ 2} - {f}_{- 2}}{1 + \frac{{K}_{u}}{{K}_{d}}}$$
$${f}_{ru 2} = \frac{{K}_{u}}{{K}_{d}} * {f}_{r d 2}$$
$${r}_{1} = \frac{c}{2} \frac{{f}_{+ 1} - {f}_{- 1}}{( 1 + \frac{{K}_{u}}{{K}_{d}} ) {K}_{d}}$$
$${r}_{2} = \frac{c}{2} \frac{{f}_{+ 2} - {f}_{- 2}}{( 1 + \frac{{K}_{u}}{{K}_{d}} ) {K}_{d}}$$
$${f}_{v 1} = \frac{{f}_{+ 1} + {f}_{- 1} - {f}_{r u 1} + {f}_{r d 1}}{2}$$
$${f}_{v 2} = \frac{{f}_{+ 2} + {f}_{- 2} + {f}_{r u 2} - {f}_{r d 2}}{2}$$
$${v}_{1} = \frac{c {f}_{v 1}}{2 {f}_{0}}$$
$${v}_{2} = \frac{c {f}_{v 2}}{2 {f}_{0}}$$
wherein f₊₁ represents the first frequency, f₋₁ represents the second frequency, f_{rd1} represents the distance beat frequency of the second beat frequency signal, fᵣᵤ₁ represents the distance beat frequency of the first beat frequency signal, Kᵤ represents the first slope, K_{d} represents the second slope, f₊₂ represents the third frequency, f₋₂ represents the fourth frequency, f_{rd2} represents the distance beat frequency of the fourth beat frequency signal, fᵣᵤ₂ represents the distance beat frequency of the third beat frequency signal, r₁ represents the first distance, c represents a propagation speed of light in the air, r₂ represents the second distance, fᵥ₁ represents the speed beat frequency of the first beat frequency signal and the second beat frequency signal, fᵥ₂ represents the speed beat frequency of the third beat frequency signal and the fourth beat frequency signal, v₁ represents the first speed, v₂ represents the second speed, and f₀ represents the central frequency of the first triangular wave signal or the second triangular wave signal, or represents an average of the central frequency of the first triangular wave signal and the central frequency of the second triangle wave signal.

9. The detection method according to claim 1, wherein based on the moving direction, the first frequency, the second frequency, the third frequency, the fourth frequency, the first slope, the second slope, and central frequency of the first triangular wave signal or the second triangular wave signal, the determining the speed of the target object relative to the laser detection apparatus and the distance therebetween comprise:
if the target object does not approach the laser detection apparatus, starting a second determining algorithm to determine distance beat frequency of the second beat frequency signal and distance beat frequency of the fourth beat frequency signal based on the first frequency, the second frequency, the third frequency, the fourth frequency, the first slope, and the second slope;
obtaining an absolute value of a difference between the distance beat frequency of the second beat frequency signal and the distance beat frequency of the fourth beat frequency signal to obtain a second absolute value; and
if the second absolute value is less than or equal to a second threshold, starting a third decoupling algorithm to determine a speed of the target object relative to the laser detection apparatus and a distance therebetween; or
if the second absolute value is greater than a second threshold, starting a fourth decoupling algorithm to determine a speed of the target object relative to the laser detection apparatus and a distance therebetween, wherein
the second determining algorithm is configured to: for a scenario in which the target object leaves the laser detection apparatus and the first beat frequency signal to the fourth beat frequency signal all satisfy that the distance beat frequency is greater than or equal to speed beat frequency, determine the distance beat frequency of the second beat frequency signal and the distance beat frequency of the fourth beat frequency signal;
the third decoupling algorithm is configured to: for a scenario in which the target object leaves the laser detection apparatus and the first beat frequency signal to the fourth beat frequency signal all satisfy that the distance beat frequency is greater than or equal to speed beat frequency, calculate the speed of the target object relative to the laser detection apparatus and the distance therebetween; or
the fourth decoupling algorithm is configured to: for a scenario in which the target object leaves the laser detection apparatus and the first beat frequency signal to the fourth beat frequency signal all satisfy that the distance beat frequency is less than speed beat frequency, calculate the speed of the target object relative to the laser detection apparatus and the distance therebetween.

10. The detection method according to claim 1, wherein based on the moving direction, the first frequency, the second frequency, the third frequency, the fourth frequency, the first slope, the second slope, and central frequency of the first triangular wave signal or the second triangular wave signal, the determining the speed of the target object relative to the laser detection apparatus and the distance therebetween comprise:
if the target object does not approach the laser detection apparatus, starting a second determining algorithm to determine distance beat frequency of the first beat frequency signal and distance beat frequency of the third beat frequency signal based on the first frequency, the second frequency, the third frequency, the fourth frequency, the first slope and the second slope;
obtaining an absolute value of a difference between the distance beat frequency of the first beat frequency signal and the distance beat frequency of the third beat frequency signal to obtain a second absolute value; and
if the second absolute value is less than or equal to a second threshold, starting a third decoupling algorithm to determine a speed of the target object relative to the laser detection apparatus and a distance therebetween; or
if the second absolute value is greater than a second threshold, starting a fourth decoupling algorithm to determine a speed of the target object relative to the laser detection apparatus and a distance therebetween, wherein
the second determining algorithm is configured to: for a scenario in which the target object leaves the laser detection apparatus and the first beat frequency signal to the fourth beat frequency signal all satisfy that the distance beat frequency is greater than or equal to speed beat frequency, determine the distance beat frequency of the first beat frequency signal and the distance beat frequency of the third beat frequency signal;
the third decoupling algorithm is configured to: for a scenario in which the target object leaves the laser detection apparatus and the first beat frequency signal to the fourth beat frequency signal all satisfy that the distance beat frequency is greater than or equal to speed beat frequency, calculate the speed of the target object relative to the laser detection apparatus and the distance therebetween; or
the fourth decoupling algorithm is configured to: for a scenario in which the target object leaves the laser detection apparatus and the first beat frequency signal to the fourth beat frequency signal all satisfy that the distance beat frequency is less than speed beat frequency, calculate the speed of the target object relative to the laser detection apparatus and the distance therebetween.

11. The detection method according to claim 1, wherein based on the moving direction, the first frequency, the second frequency, the third frequency, the fourth frequency, the first slope, the second slope, and central frequency of the first triangular wave signal or the second triangular wave signal, the determining the speed of the target object relative to the laser detection apparatus and the distance therebetween comprise:
if the target object does not approach the laser detection apparatus and the second frequency is less than the fourth frequency, starting a third decoupling algorithm to determine a speed of the target object relative to the laser detection apparatus and a distance therebetween; or
if the target object does not approach the laser detection apparatus and the second frequency is greater than the fourth frequency, starting a fourth decoupling algorithm to determine a speed of the target object relative to the laser detection apparatus and a distance therebetween, wherein
the third decoupling algorithm is configured to: for a scenario in which the target object leaves the laser detection apparatus and the first beat frequency signal to the fourth beat frequency signal all satisfy that distance beat frequency is greater than or equal to speed beat frequency, calculate the speed of the target object relative to the laser detection apparatus and the distance therebetween; or
the fourth decoupling algorithm is configured to: for a scenario in which the target object leaves the laser detection apparatus and the first beat frequency signal to the fourth beat frequency signal all satisfy that the distance beat frequency is less than speed beat frequency, calculate the speed of the target object relative to the laser detection apparatus and the distance therebetween.

12. The detection method according to claim 9, wherein
if the first slope is greater than the second slope, the method further comprises:
if the third decoupling algorithm is started, determining a speed beat frequency of the second beat frequency signal and a speed beat frequency of the fourth beat frequency signal based on the third decoupling algorithm; and
if the distance beat frequency of the second beat frequency signal is greater than or equal to the speed beat frequency, and the distance beat frequency of the fourth beat frequency signal is greater than or equal to the speed beat frequency, determining that the speed of the target object relative to the laser detection apparatus and the distance therebetween that are determined based on the third coupling algorithm pass a check, and
if the first slope is greater than the second slope, the method further comprises:
if the fourth decoupling algorithm is started, determining a speed beat frequency of the second beat frequency signal and a speed beat frequency of the fourth beat frequency signal based on the fourth decoupling algorithm; and
if the distance beat frequency of the second beat frequency signal is less than the speed beat frequency, and the distance beat frequency of the fourth beat frequency signal is less than the speed beat frequency, determining that the speed of the target object relative to the laser detection apparatus and the distance therebetween that are determined based on the fourth coupling algorithm pass a check.

13. The detection method according to claim 9, wherein the starting the third decoupling algorithm to determine the speed of the target object relative to the laser detection apparatus and the distance therebetween, and the starting the fourth decoupling algorithm to determine the speed of the target object relative to the laser detection apparatus and the distance therebetween both comprise:
based on the first frequency, the second frequency, the first slope and the second slope, determining a first distance between the target object and the laser detection apparatus at the first sweep time;
based on the first frequency, the second frequency, the first slope, the second slope, and central frequency of the first triangular wave signal and/or the second triangular wave signal, determining a first speed of the target object relative to the laser detection apparatus at the first sweep time;
based on the third frequency, the fourth frequency, the first slope and the second slope, determining a second distance between the target object and the laser detection apparatus at the second sweep time; and
based on the third frequency, the fourth frequency, the first slope, the second slope, and central frequency of the first triangular wave signal and/or the second triangular wave signal, determining a second speed of the target object relative to the laser detection apparatus at the second sweep time.

14. The detection method of a laser detection apparatus according to claim 13, wherein the third decoupling algorithm comprises the following formulas:
$${f}_{r d 1} = \frac{{f}_{+ 1} + {f}_{- 1}}{1 + \frac{{K}_{u}}{{K}_{d}}}$$
$${f}_{ru 1} = \frac{{K}_{u}}{{K}_{d}} * {f}_{r d 1}$$
$${f}_{r d 2} = \frac{{f}_{+ 2} + {f}_{- 2}}{1 + \frac{{K}_{u}}{{K}_{d}}}$$
$${f}_{ru 2} = \frac{{K}_{u}}{{K}_{d}} * {f}_{r d 2}$$
$${r}_{1} = \frac{c}{2} \frac{{f}_{+ 1} + {f}_{- 1}}{( 1 + \frac{{K}_{u}}{{K}_{d}} ) {K}_{d}}$$
$${r}_{2} = \frac{c}{2} \frac{{f}_{+ 2} + {f}_{- 2}}{( 1 + \frac{{K}_{u}}{{K}_{d}} ) {K}_{d}}$$
$${f}_{v 1} = \frac{{f}_{+ 1} - {f}_{- 1} - {f}_{r u 1} + {f}_{r d 1}}{2}$$
$${f}_{v 2} = \frac{{f}_{+ 2} - {f}_{- 2} - {f}_{r u 2} + {f}_{r d 2}}{2}$$
$${v}_{1} = \frac{c {f}_{v 1}}{2 {f}_{0}}$$
$${v}_{2} = \frac{c {f}_{v 2}}{2 {f}_{0}}$$
the fourth decoupling algorithm comprises the following formulas:
$${f}_{r d 1} = \frac{{f}_{+ 1} - {f}_{- 1}}{1 + \frac{{K}_{u}}{{K}_{d}}}$$
$${f}_{ru 1} = \frac{{K}_{u}}{{K}_{d}} * {f}_{r d 1}$$
$${f}_{r d 2} = \frac{{f}_{+ 2} - {f}_{- 2}}{1 + \frac{{K}_{u}}{{K}_{d}}}$$
$${f}_{r u 2} = \frac{{K}_{u}}{{K}_{d}} * {f}_{r d 2}$$
$${r}_{1} = \frac{c}{2} \frac{{f}_{+ 1} - {f}_{- 1}}{( 1 + \frac{{K}_{u}}{{K}_{d}} ) {K}_{d}}$$
$${r}_{2} = \frac{c}{2} \frac{{f}_{+ 2} - {f}_{- 2}}{( 1 + \frac{{K}_{u}}{{K}_{d}} ) {K}_{d}}$$
$${f}_{V 1} = \frac{{f}_{+ 1} + {f}_{- 1} + {f}_{r u 1} - {f}_{τ d 1}}{2}$$
$${f}_{v 2} = \frac{{f}_{+ 2} + {f}_{- 2} - {f}_{r u 2} + {f}_{r d 2}}{2}$$
$${v}_{1} = \frac{c {f}_{v 1}}{2 {f}_{0}}$$
$${v}_{2} = \frac{c {f}_{v 2}}{2 {f}_{0}}$$
wherein f₊₁ represents the first frequency, f₋₁ represents the second frequency, f_{rd1} represents the distance beat frequency of the second beat frequency signal, fᵣᵤ₁ represents the distance beat frequency of the first beat frequency signal, Kᵤ represents the first slope, K_{d} represents the second slope, f₊₂ represents the third frequency, f₋₂ represents the fourth frequency, f_{rd2} represents the distance beat frequency of the fourth beat frequency signal, fᵣᵤ₂ represents the distance beat frequency of the third beat frequency signal, r₁ represents the first distance, c represents a propagation speed of light in the air, r₂ represents the second distance, fᵥ₁ represents the speed beat frequency of the first beat frequency signal and the second beat frequency signal, fᵥ₂ represents the speed beat frequency of the third beat frequency signal and the fourth beat frequency signal, v₁ represents the first speed, v₂ represents the second speed, and f₀ represents the central frequency of the first triangular wave signal or the second triangular wave signal, or represents an average of the central frequency of the first triangular wave signal and the central frequency of the second triangle wave signal.

15. A laser detection apparatus, comprising:
a first laser emission unit, configured to control a first laser to generate a first triangular wave signal in each sweep period, wherein emission power of the first laser is first power, a sweep slope of the first triangular wave signal is a first slope, and the sweep period comprises first sweep time and second sweep time connected in sequence;
a second laser emission unit, configured to control a second laser to generate a second triangular wave signal in each sweep period, wherein emission power of the second laser is second power different from the first power, a sweep slope of the second triangular wave signal is second slope, and the second slope is different from the first slope;
a photoelectric conversion unit, configured to control a photoelectric detection module to receive a first local oscillator signal, an echo signal of a first detection signal, a second local oscillator signal and an echo signal of a second detection signal, wherein the first local oscillator signal and the first detection signal are two signals formed via beam splitting of the first triangular wave signal, the first local oscillator signal comprises a first upper-sweep local oscillator signal at the first sweep time and a second lower-sweep local oscillator signal at the second sweep time, the first detection signal comprises a first upper-sweep detection signal at the first sweep time and a second lower-sweep detection signal at the second sweep time, the second local oscillator signal and the second detection signal are two signals formed via beam splitting of the second triangular wave signal, the second local oscillator signal comprises a first lower-sweep local oscillator signal at the first sweep time and a second upper-sweep local oscillator signal at the second sweep time, and the second detection signal comprises a first lower-sweep detection signal at the first sweep time and a second upper-sweep detection signal at the second sweep time;
a first frequency obtaining unit, configured to obtain first frequency and second frequency at the first sweep time, wherein the first frequency is a higher one of frequency of a first beat frequency signal and frequency of a second beat frequency signal, the second frequency is a lower one of the frequency of the first beat frequency signal and the frequency of the second beat frequency signal, the first beat frequency signal is a beat frequency signal of the first upper-sweep local oscillator signal and an echo signal of the first upper-sweep detection signal, and the second beat frequency signal is a beat frequency signal of the first lower-sweep local oscillator signal and an echo signal of the first lower-sweep detection signal;
a second frequency obtaining unit, configured to obtain third frequency and fourth frequency at the second sweep time, wherein the third frequency is a higher one of frequency of a third beat frequency signal and frequency of a fourth beat frequency signal, the fourth frequency is a lower one of the frequency of the third beat frequency signal and the frequency of the fourth beat frequency signal, the third beat frequency signal is a beat frequency signal of the second lower-sweep local oscillator signal and an echo signal of the second lower-sweep detection signal, and the fourth beat frequency signal is a beat frequency signal of the second upper-sweep local oscillator signal and an echo signal of the second upper-sweep detection signal;
a moving direction determining unit, configured to: based on a magnitude relationship between the first power and the second power and a magnitude relationship between amplitudes of the first frequency and the second frequency, determine a moving direction of a target object relative to the laser detection apparatus at the first sweep time; or based on a magnitude relationship between the first power and the second power and a magnitude relationship between amplitudes of the third frequency and the fourth frequency, determine a moving direction of a target object relative to the laser detection apparatus at the second sweep time; and
a distance and speed determining unit, configured to: based on the moving direction, the first frequency, the second frequency, the third frequency, the fourth frequency, the first slope, the second slope, and central frequency of the first triangular wave signal and/or the second triangular wave signal, determine a speed of the target object relative to the laser detection apparatus and a distance therebetween.

16. A laser detection apparatus, comprising:
a processor; and
a memory, connected with the processor communicatively, wherein the memory stores a program executable by the processor, and the processor is configured to run the program, so that the laser detection apparatus performs steps of the detection method of a laser detection apparatus according to claim 1.
